(19) United States
(12) Patent Application Publication
(10) Pub. No.: US 2004/0030563 A1
(43) Pub. Date: Feb. 12, 2004

(54) Portal value indicator framework and tool

(76) Inventors: John C. Porcari, Bridgeville, PA (US); Kenneth L. Cundari, Wayland, MA (US); Clinton D. Blosser, Morgantown, WV (US)

Correspondence Address: ACCENTURE C/O MORRISON & FOERSTER, 755 PAGE MILL ROAD, PALO ALTO, CA, 94304, US

(21) Appl. No.: 10/216,031

(22) Filed: Aug. 9, 2002

(51) Int. Cl. G06F 17/60

(52) U.S. Cl. 705/1

(57) ABSTRACT

The invention pertains to a method and framework and tool for use in developing robust “as-is” and “to-be” cost and benefit summaries for a proposed Enterprise portal in a fast and efficient manner. The cost & benefit summaries make use of core business process data and critical workforce (per industry segment) data which are used along with cross-enterprise efficiency data to produce the Business Case summary reports. The system provides an efficient and effective way of showing the added value which an enterprise portal would bring to strategic business goals.

### FIELD OF THE INVENTION

This invention relates to the field of Computer Systems and more particularly to a framework and tool for use in developing an efficient and effective plan for showing the added value which an Enterprise Portal would bring to Strategic Business Goals.

### BACKGROUND OF THE INVENTION

It is desirable that a framework be available for determining values and characteristics of (1) Critical Workforce Effectiveness, (2) Cross Enterprise Efficiencies and (3) Desktop support and application delivery areas (Technology). These values and characteristics can be related to an Enterprise Project, such as, for example, an Enterprise Portal which supports specific strategic business goals. It is desirable to evaluate these three categories “as-is” and to project the changes in these categories and their related costs for a proposed Enterprise portal system (a “to-be” system) which can support either the same strategic business goals more cost effectively or which can support a new set of specific business goals. Moreover it is desirable to have a tool (computer related system) to assist in calculating the as-is and to-be areas and in demonstrating the net benefits which may be realized by the to-be configuration.

For example, in the wake of recent B2B and dot.com business failures, responsible businesses are continuing to ask “How can we effectively use current telecommunications and computing systems to enhance our business?” In the article titled “Friendly Foes” Red Herring (04/02) No. 112, P. 54; Pfeiffer, Eric W. describes the present business needs. He points out that the Yankee Group estimates that $3.3 billion will be invested in collaboration technologies over the next four years, although collaboration by itself is nothing new. The failure of business-to-business (B2B) exchanges has fueled a need for a deeper form of collaboration. He further indicates in the March 2001 Harvard Business Review that, Harvard Business School professor Michael Porter urged B2B exchanges to move away from differentiation based on price and “instead focus on product selection, product design, service, image and other areas in which they can differentiate themselves.” The automotive industry is often referred to as a model of collaboration: The Covisint™ exchange, for example, is deploying product life cycle management (PLM) applications that facilitate collaborative vehicle design and assembly, and AMR Research™ believes PLM could save car companies $250 in production costs per vehicle. With deeper collaboration, Digital 4Sight™ co-founder Don Tapscott foresees the vertically integrated corporate structure giving way to “business webs”—networks of companies, suppliers, and customers tightly woven into “extended supply chains.” Unfortunately, the collaboration many companies currently boast is ineffective and new and cost effective collaborations both internally as well as with outside companies are difficult to assess and evaluate in the design and pre-implementation stages. The use of “core business processes” and “critical workforce (per industry segment)” models have not been used in current portal evaluations.

Earlier attempts to make such as-is and to-be value calculations have traditionally focused on paper savings and headcount savings. What is needed is a process which focuses on the “critical workforce segments” and the related key value levers, which have been shown to make or break the success of a portal.

The present invention provides a framework and tool to demonstrate, for example, that an enterprise portal used for internal collaboration between departments or divisions, or for external collaboration between suppliers and customers, can be designed for increased value when the portal is designed around an “employee to task” set of relationships. Moreover the present invention provides a mechanism for displaying the “as-is” versus “to-be” benefits and costs related to various aspect of the exemplary portal design elements.

### BRIEF SUMMARY OF THE INVENTION

The invention pertains to a method and framework and tool for use in developing robust “as-is” and “to-be” cost and benefit summaries for a proposed Enterprise portal in a fast and efficient manner. The cost & benefit summaries make use of core business process data and critical workforce (per industry segment) data, including key value lever per workforce segment data, which are used along with cross-enterprise efficiency data to produce the Business Case summaries.

Several methods are claimed for using a computer implemented framework to develop new and unique views of cost and benefit summaries for a proposed enterprise portal, which include the effects of critical workforce segments and key value levers related to each workforce segment.

An apparatus is also claimed for use with a framework to develop new and unique views of cost and benefit summaries for a proposed enterprise portal, which include the effects of critical workforce segments and key value levers related to each workforce segment.

A computer system is also claimed having computer hardware and a software tool for use in developing new and unique views of cost and benefit summaries for a proposed enterprise portal, which include the effects of critical workforce segments and key value levers related to each workforce segment.

A server computer is claimed having computer hardware and a software tool for use in developing new and unique views of cost and benefit summaries for a proposed enterprise portal, which include the effects of critical workforce segments and key value levers related to each workforce segment, which can be outputted to a client computer.

A computer program product is claimed having logic mechanisms for use in developing new and unique views of cost and benefit summaries for a proposed enterprise portal, which include the effects of critical workforce segments and key value levers related to each workforce segment, which can be outputted to a computer display.

### BRIEF DESCRIPTION OF THE SEVERAL VIEWS OF THE DRAWINGS

FIG. 1 illustrates a typical Internet network configuration.

FIG. 2 illustrates a representative general purpose computer configuration which may be used as a client computer, host computer, router, etc.

FIG. 3 depicts the Enterprise Portal—Value Indicator framework.

FIG. 4 illustrates an exemplary Main Menu screen for the tool used with the present invention.

FIG. 5 illustrates an exemplary screen shot of a Key Strategic Business Goals input form.

FIG. 6 illustrates an exemplary entry screen for use in inputting critical workforce segments for a given core business process and sub-process.

FIG. 7 illustrates an exemplary hierarchy of core business processes and sub-processes.

FIG. 8 illustrates an exemplary list of critical workforce segments by core business process and sub-process.

FIG. 9 illustrates an exemplary list of critical workforce segments try group and sub-group.

FIG. 10 illustrates an exemplary list of potential value levers for growth, cost reduction and for working capital and fixed asset management.

FIGS. 11A and 11B illustrate an exemplary input screen for inputting as-is data for various value levers.

FIG. 12 illustrates an exemplary screen for use in calculating the monthly unit payroll cost.

FIG. 13 illustrates an exemplary screen for inputting as-is data for value levers for estimating current costs for years 2 and 3.

FIGS. 14A, and 14B illustrate an exemplary input form the input of data to compute projected (to-be) portal impact information for year 1.

FIG. 15 illustrates an exemplary form for inputting data to calculate expected values for years 2 and 3.

FIG. 16 illustrates an exemplary screen form for selecting Cross-Enterprise Dimensions to be evaluated.

FIG. 17 illustrates an exemplary screen form for entry of data for a Cross Enterprise dimension activity.

FIGS. 18A and 18B illustrate an exemplary screen form for entry of data related to the technological impact (costs) of a portal installation.

FIGS. 19A, 19B, 19C and 19D illustrate an exemplary screen form of data related to the implementation of a portal.

FIG. 20 illustrates an exemplary screen form which indicates the reports available from the tool and which permits the selection thereof.

FIGS. 21A and 21B illustrate an exemplary Overall Portal Business Case Summary Report.

FIG. 22 illustrates an exemplary Portal Business Case by Core Business Process and Sub-process Report.

FIG. 23 illustrates an exemplary Portal Business Case by Goals and Value Lever Impact report.

FIG. 24 illustrates an exemplary Portal Business Case by Critical Workforce Segment Report.

FIG. 25 illustrates a depiction of the various data tables in Microsoft Assess used in the exemplary illustration of the invention showing their relationship to each other.

FIG. 26 illustrates a Portal Value Indicator Tool Application Flow Diagram used in the exemplary embodiment of the invention.

### DETAILED DESCRIPTION OF THE INVENTION

The present invention provides a method and system for evaluating the As-is and To-be (i.e. proposed) costs and benefits of acquiring and operating a new enterprise portal. To illustrate the basic invention, an exemplary project for evaluating the costs and benefits of acquiring and operating an enterprise portal will be described which is directed at identified business goals and the attainment of budgeted goals therefor. Mechanisms are provided for accumulating costs and benefits for cost and benefit levers related to workforce segments and core business process and sub-processes for the stated strategic business goals. Mechanisms are also provided for relating similar data to include and display cross-enterprise efficiencies. Electronic displays and hard copy reports of the various summary and detail data are provided.

In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

### Operating Environment

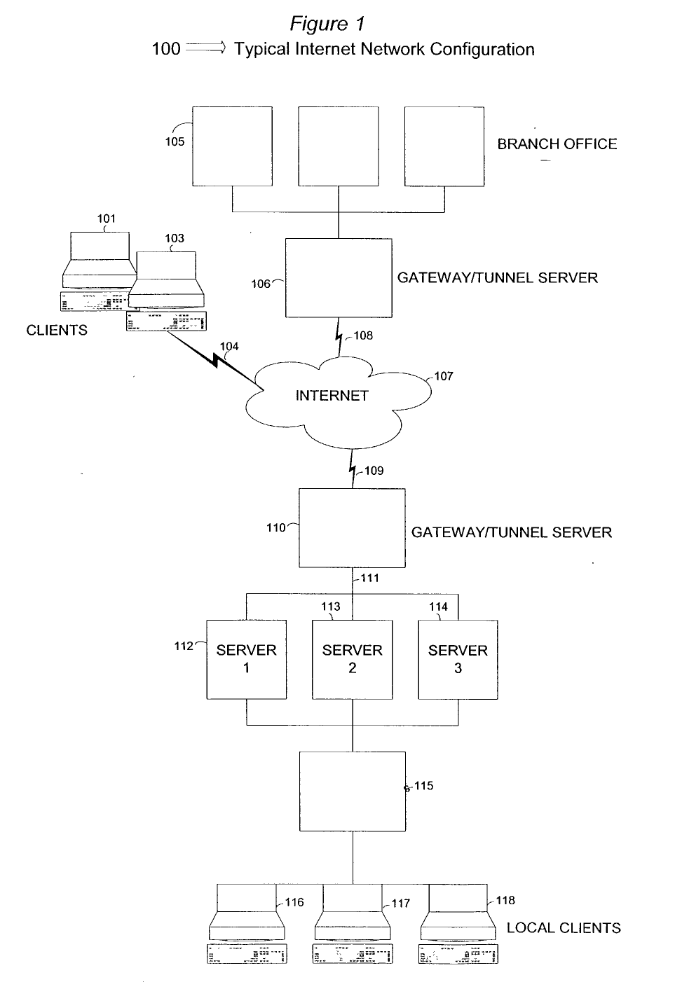

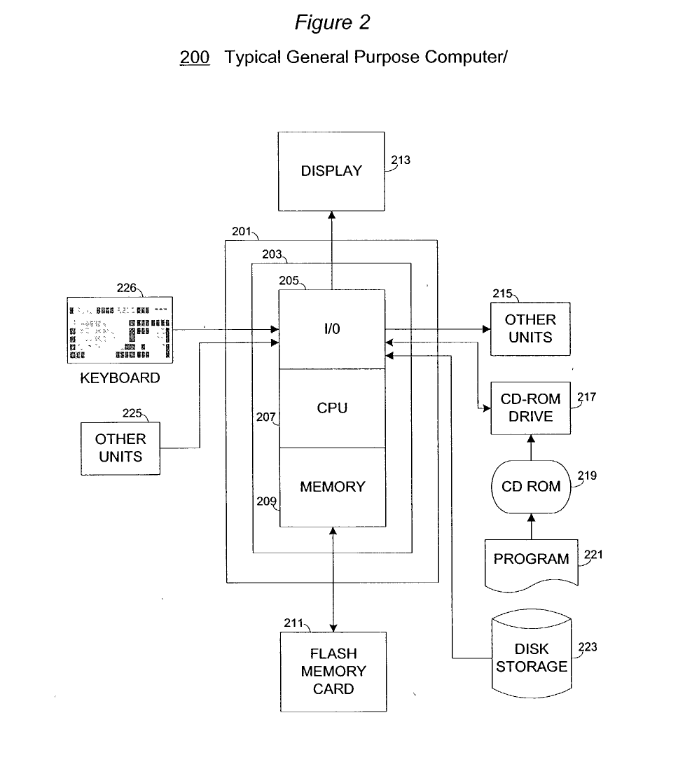

The environment in which the present invention is used encompasses the general distributed computing scene which includes generally local area networks with hubs, routers, gateways, tunnel-servers, applications servers, etc. connected to other clients and other networks via the Internet, wherein programs and data are made available by various members of the system for execution and access by other members of the system. Some of the elements of a typical internet network configuration are shown in FIG. 1, wherein a number of client machines 105 possibly in a branch office of an enterprise, are shown connected to a Gateway/hub/tunnel-server/etc. 106 which is itself connected to the internet 107 via some internet service provider (ISP) connection 108. Also shown are other possible clients 101, 103 similarly connected to the internet 107 via an ISP connection 104, with these units communicating to possibly a home office via an ISP connection 109 to a gateway/tunnel-server 110 which is connected 111 to various enterprise application servers 112, 113, 114 which could be connected through another hub/router 115 to various local clients 116, 117, 118. The present invention may be performed on one or more of a number of general purpose computer units each of which includes generally the elements shown in FIG. 2, wherein the general purpose system 201 includes a motherboard 203 having thereon an input/output (“I/O”) section 205, one or more central processing units (“CPU”) 207, and a memory section 209 which may have a flash memory card 211 related to it. The I/O section 205 is connected to a keyboard 226, other similar general purpose computer units 225, 215, a disk storage unit 223 and a CD-ROM drive unit 217. The CD-ROM drive unit 217 can read a CD-ROM medium 219 which typically contains programs 221 and other data. Logic circuits or other components of these programmed computers will perform series of specifically identified operations dictated by computer programs as described more fully below.

Generally, in the exemplary embodiment, the programs used include Microsoft™ OS version 2000, Microsoft Access™ version 2000 SRI, Microsoft Visual Basic™ for Applications, and MS Office™ 2000, using client computer hardware which has installed and can support these Microsoft systems, including most laptop computers such as a Toshiba Protege™ 3480CT. Any client computer workstation including a laptop computer which supports the above listed programs can function as the means for receiving inputted data, and displaying any of the associated reports, as these are described herein below. Those familiar with Access™ will understand that complex database tables and related queries and reports can be constructed as described in any number of commonly available manuals and user guides on Microsoft Access, such as for example, “Microsoft Access 2000 Bible with CD-ROM” by Cary N. Prague and Michael Irwin, Wiley, 1999, ISBN: 0764532863.

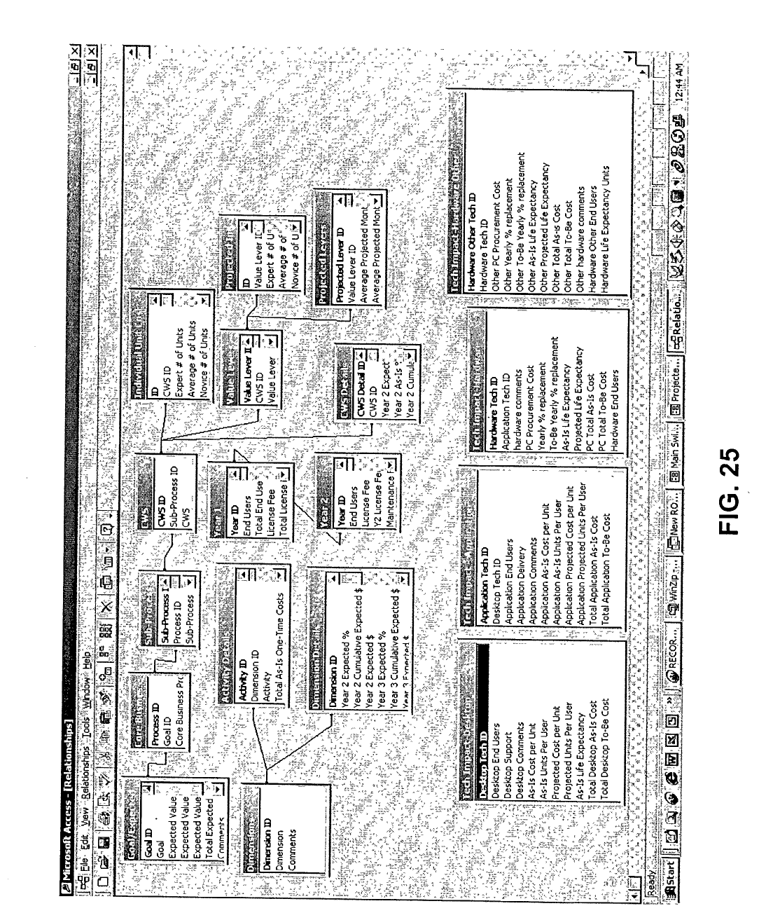

For the exemplary model of Access tables and their inter-relationships see the chart shown in FIG. 25. Those skilled in these arts will understand that other operating systems, and other supporting spread sheet systems, display systems, database systems, hardware platforms, and telecommunications systems and protocols may be used to accomplish equivalent mechanisms in support of this .

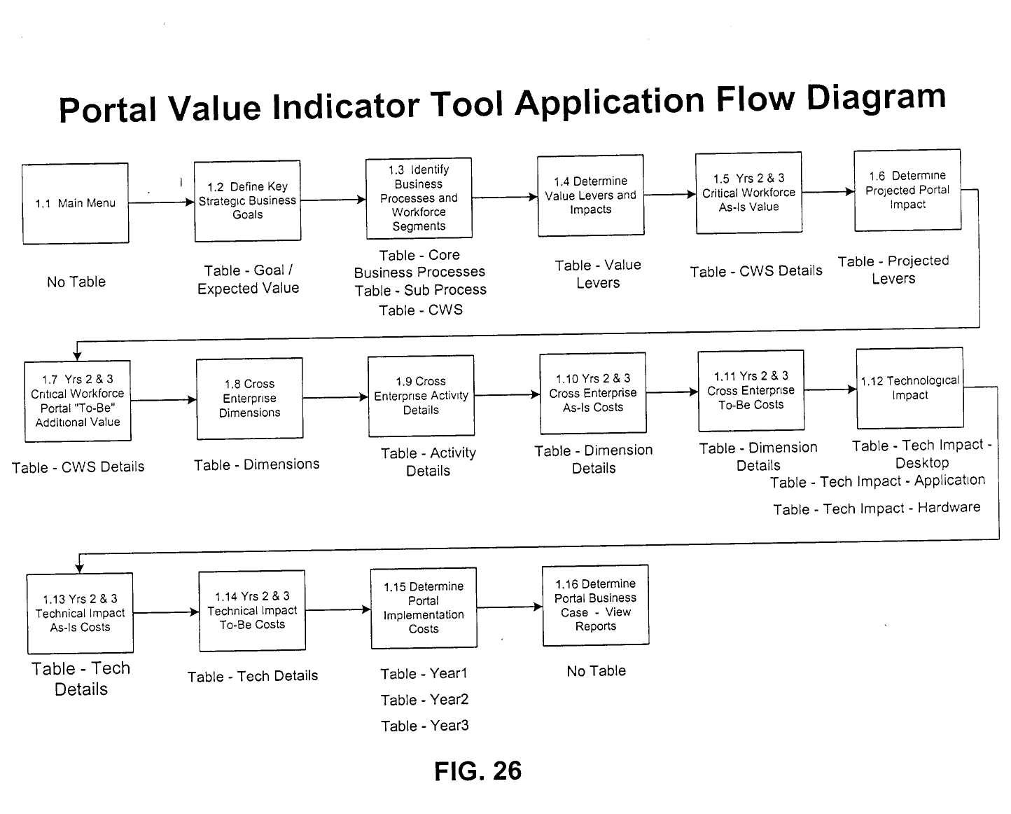

A functional flow diagram of the tool used in the exemplary embodiment of the invention is shown in FIG. 26. The steps in this Portal value Indicator Tool Application Flow Diagram are described in more detail in the detailed description of the use of the tool in connection with the preferred embodiment as follows.

### Overview of a Preferred Embodiment

When considering whether to implement a portal, it's essential to determine how the portal will help a company achieve its key strategic business goals. The Enterprise Portals Value Indicator Process and Tool of the present invention can be used to help determine, in anticipated dollar values, how a company's portal investment will contribute toward its key strategic business goals.

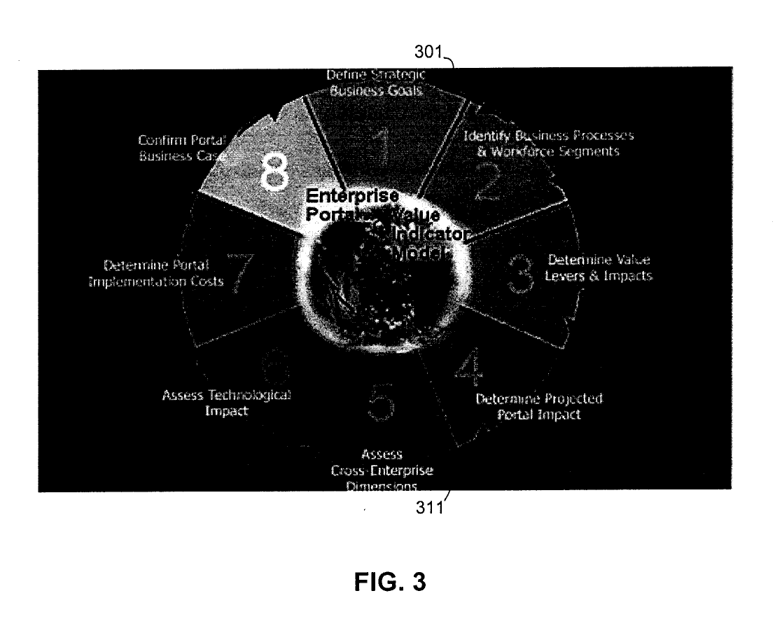

In a preferred embodiment a high-level Portal Value Indication process can be illustrated with reference to the Portal Value Proposition framework shown in FIG. 3. As indicated in FIG. 3, the first step is to “define strategic business goals” 301, which can be characterized as defining the strategic business goals to enable one to focus on critical areas that the portal should support.

Step 2 of the exemplary process 303 can be characterized as identifying processes and critical workforce segments to allow one to begin to determine which business activities and workforces are essential to achieving the goals.

Step 3 in the exemplary process 305 may be characterized as for each critical workforce segment, determining value levers and their impacts which will help to identify which of their activities are critical to achieving the business goals, and to specify the way in which those activities impact the goal.

Step 4 in the exemplary process 309 may be characterized as documenting current “As-Is” operations to benchmark how value is generated without an enterprise portal. For each lever, the As-Is Analysis documents costs, returns, and net profits for the current mode of doing business.

Step 5 of the exemplary process 311 may be characterized as for each lever, the Portal Value documents costs, returns, and net profits for the projected (with-portal) mode of achieving the key strategic business goals.

Step 6 of the exemplary process 313 can be characterized as assessing cross-enterprise efficiencies to ensure that specific business portal benefits that may not necessarily link directly to a goal are considered.

Step 7 of the exemplary process 315 can be characterized as assessing the technological impact to help to quantify specific hardware, software, and related processing costs and benefits associated with implementing and operating a portal.

Step 8 of the exemplary process 317 can be characterized as reviewing the business case with the evaluation team and with clients to verify that the assumptions and numbers are accurate and to make corrections as needed.

These eight broad steps in the process of the present invention are now described in more detail with respect to the use of the tool which forms a part of the present invention.

### The Portal Value Indicator Tool

In the exemplary embodiment, the Portal Value Indicator Tool which is a part of the invention, comprises a specific database and a Microsoft Access program which makes use of Access forms and screens for inputting data necessary to populate the database for a specific Business Case. The program additionally provides for calculation and extension of various data values and for the production of various summary reports as illustrated below. The database tables and their exemplary relationships are shown in FIG. 25. The use of the exemplary forms for data input and display will be described in more detail below.

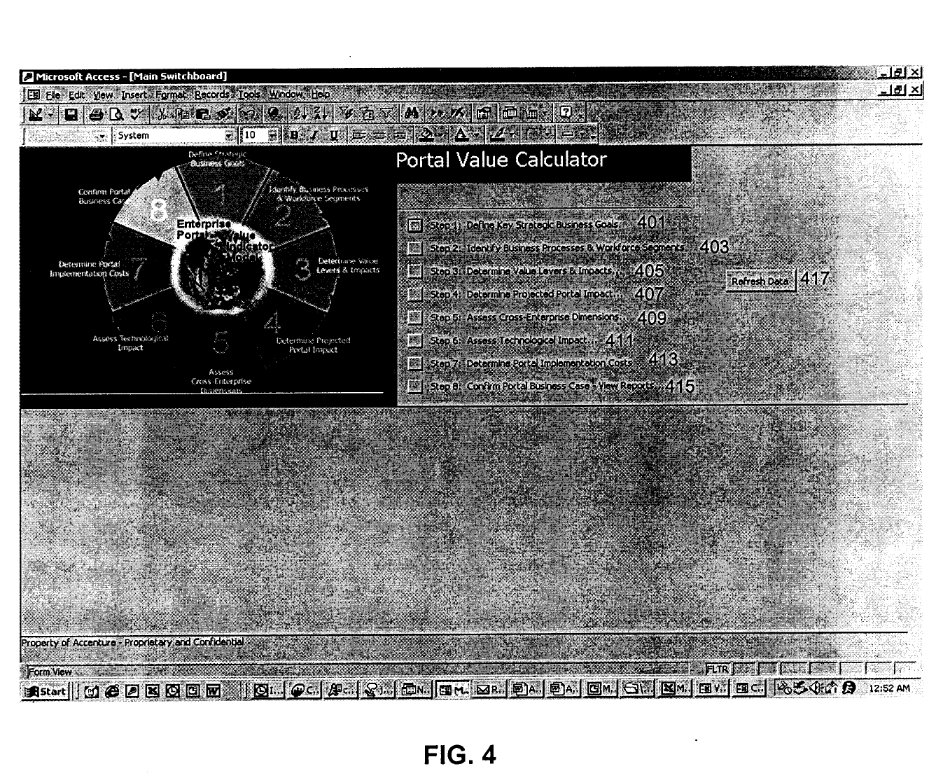

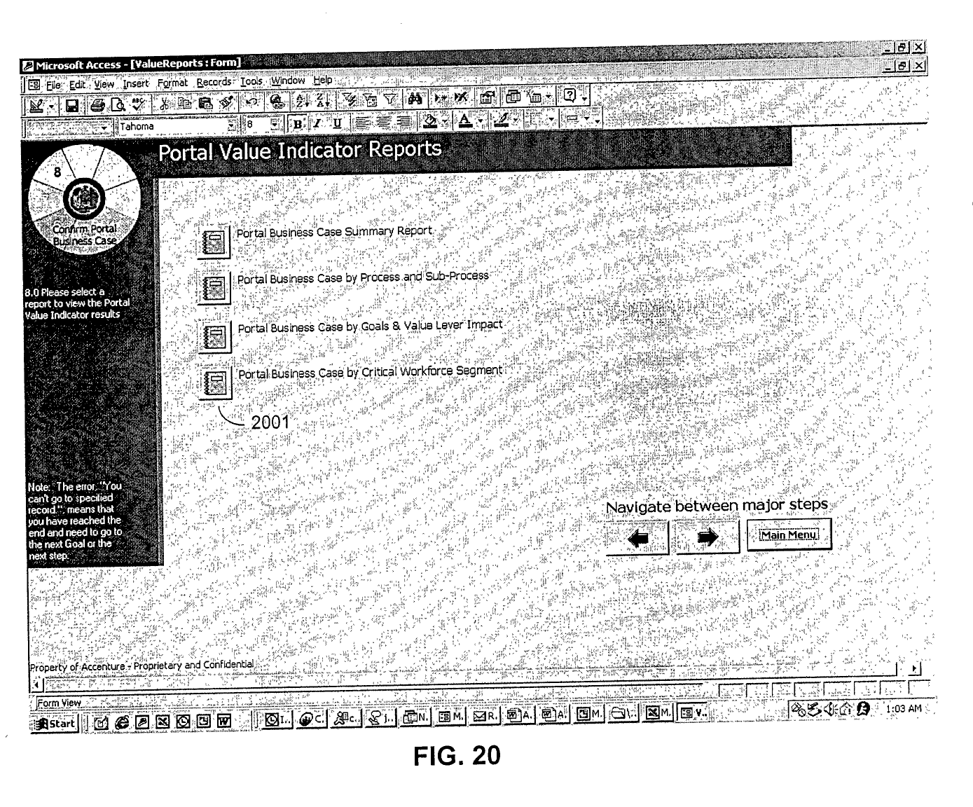

In the exemplary embodiment, the tool itself is called by clicking on a program icon designated “Portal ROI Calculator.MDB”. As each screen form is displayed and the relevant data entered, the database is populated with the data when the next screen is called. When the last data is input, the user can call the report summary screen FIG. 20, to select one or more of the available summary reports. Each screen has “Navigate Between Major Steps” buttons which will take the user to the Previous Screen, Next Screen or to the Main Menu FIG. 4.

### Use of the Portal Value Indicator Framework and Tool

The following is a description of an exemplary use of the present invention, describing in more detail the process of using the framework and tool.

### Define Strategic Business Goals

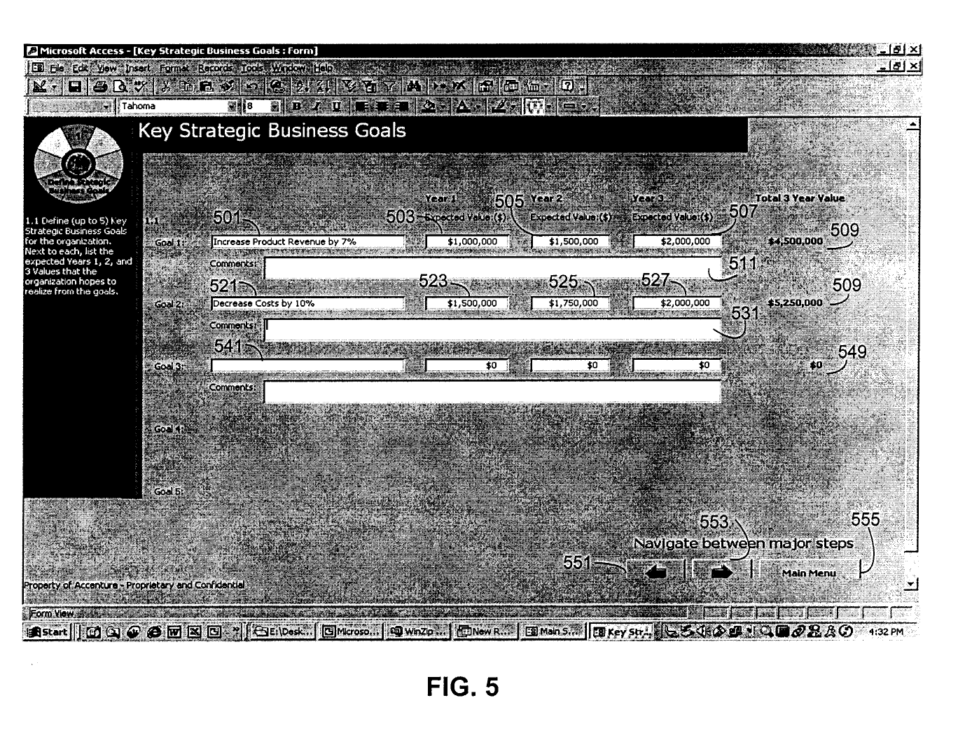

In an exemplary process, the use of the tool in the process would proceed as follows. First, one begins by defining the client's strategic business goals and the company's as-is expected value for each goal. A strategic business goal is a high-level organization-wide goal that directs the client's business over a prolonged period of time—typically from 1 to 5 years. Usually there are a limited number of strategic business goals, seldom more than three. A client's continued success often rests upon achieving its strategic business goals, but these goals aren't always clearly spelled out. Next, on a client computer, the tool is called which causes a screen display to appear titled “Portal Value Calculator” FIG. 4. In the exemplary embodiment, this screen is the main menu which guides the user through the steps used in the entire process. The button for step 1401 is clicked and the Key Strategic Goal form is displayed FIG. 5. Goals are typed in the space provided, as in boxes 501, 521, 541. And the estimated values of the goals are typed in the space provided, 503, 505, 507, 523, 525, 527, etc. Comments may be added for each goal in the window provided 511, 531.

The total 3 Year value for each goal will populate automatically based on what's entered in the other value fields 509, 529, 549.

If the user types data into the Goal 3 box 541 the tool displays additional window boxes for Goal 4 data. Similarly, if the user types data into the Goal 4 boxes (not shown) the tool will display additional window boxes for Goal 5. a maximum of five (5) Goals are allowed.

When these goals related data are entered, the user may click the next screen button 553 to go to the next screen, or the user may click the “main Menu” button 555 to return to the main menu FIG. 4. Navigate button 551 will take the user to the Previous screen. When the user is ready she may proceed to the next step by clicking on the step icon 403 in FIG. 4.

### Identify Core Business Processes, Sub-Processes, and Critical Workforce Segments

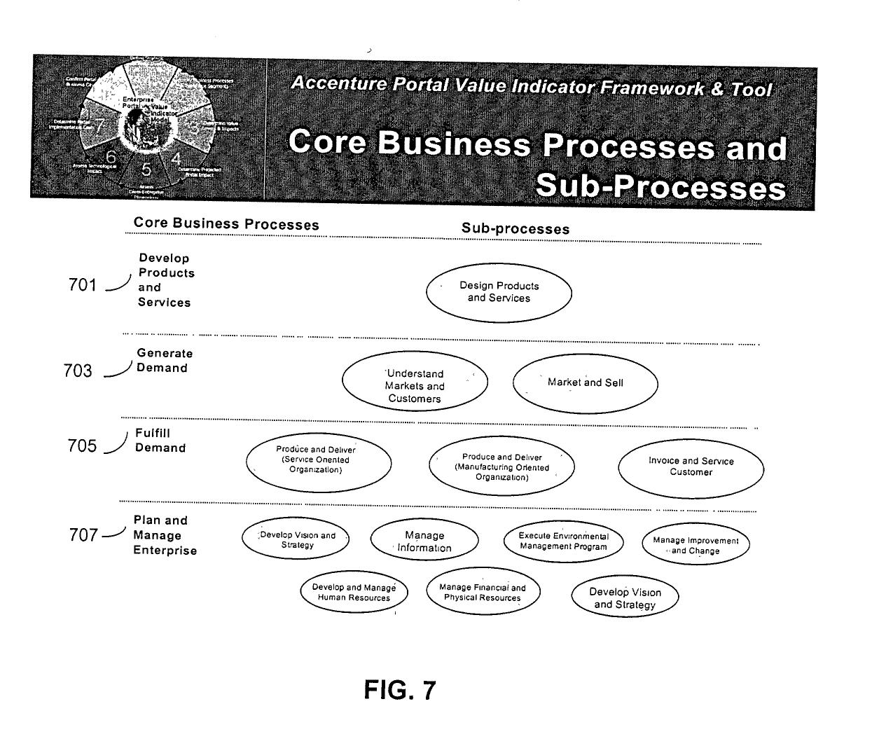

Once the strategic business goals have been defined, the next step is to figure out which business processes and workforces have the capacity to influence the goal's outcome. FIG. 7 shows exemplary business processes and sub-processes.

One begins by figuring out which core business process drives each goal. A core business process defines an organization's market-driven processes of designing (Develop Products and Services) 701, selling (Generate Demand) 703, and delivering products (Fulfill Demand) 705, as well as the infrastructural processes that support the organization's information, financial, and human resources needs (Plan and Manage Enterprise) 707.

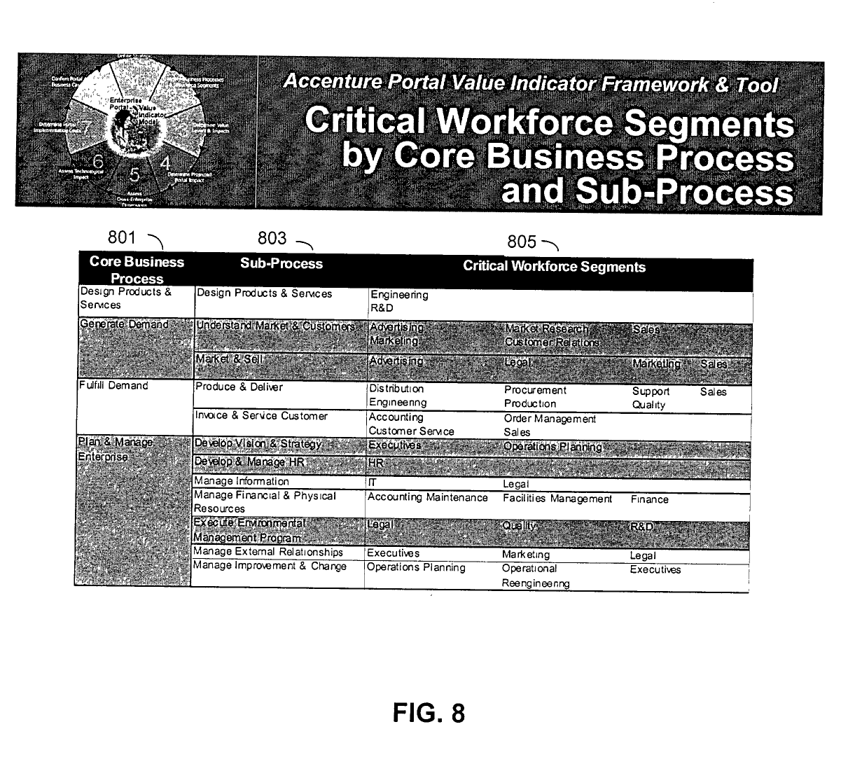

After figuring out which core business process drives a-goal, one needs to determine which sub-processes are critical to the goal's success. Not all sub-processes may be relevant to a given goal. Certain workforces support each sub-process. One needs to determine which workforces are critical to achieving each goal. It may help to focus on workforces associated with specific core business processes and sub-process. FIG. 8 shows core business processes 801, sub-processes 803, and their associated critical workforce segments 805.

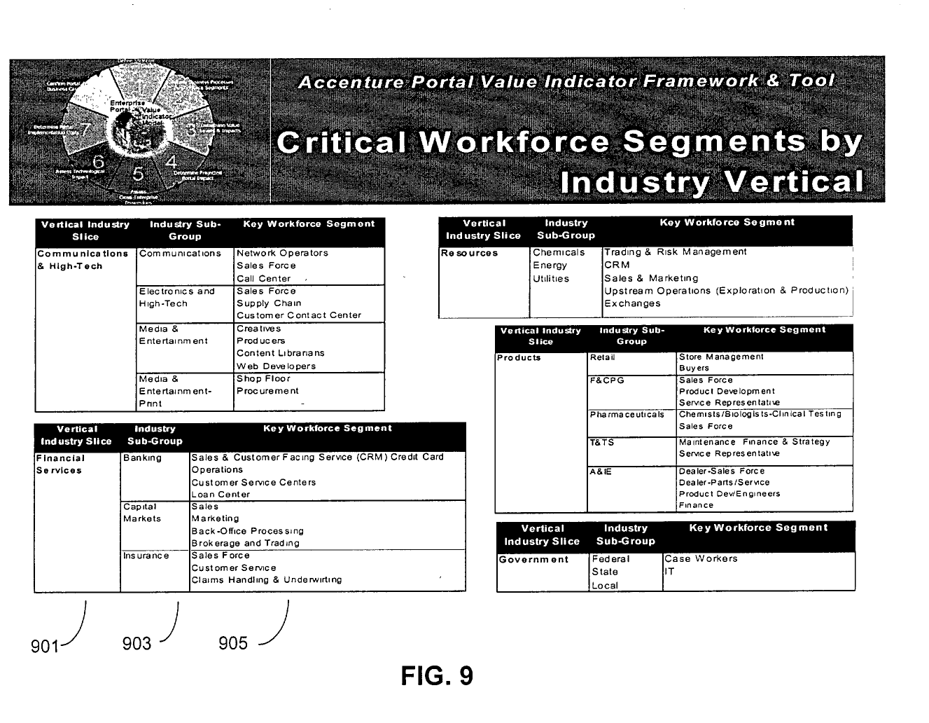

Additionally, one may want to consider which critical workforces are associated with a given industry slice. FIG. 9 shows which critical workforces are associated with different industries. For example, in the Financial Services Industry 901, the critical workforces 905 are shown for each industry sub-group 903.

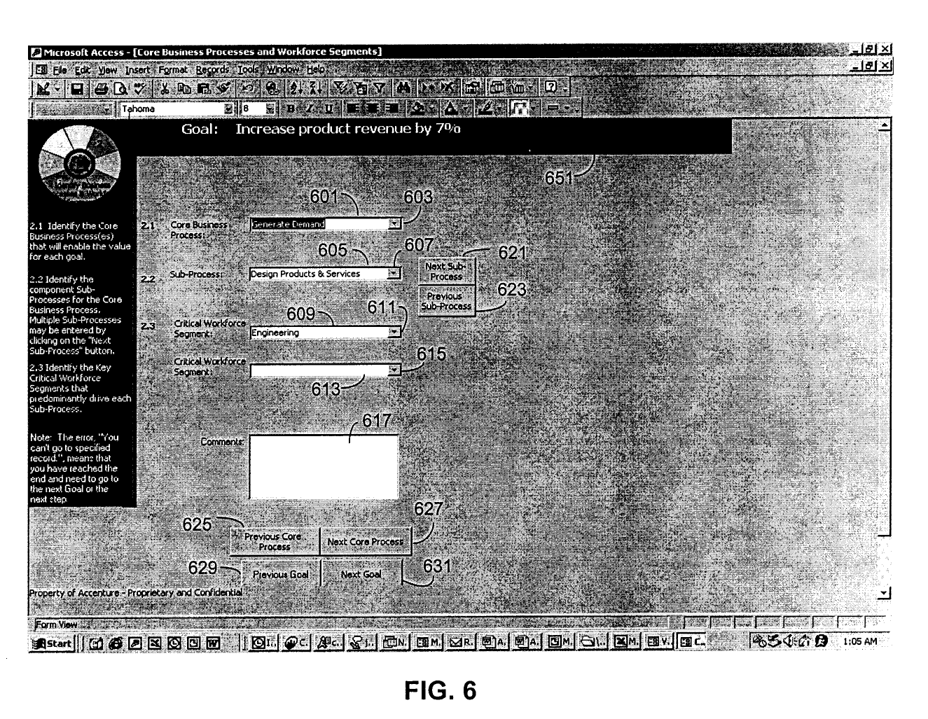

Once the core business processes, sub-processes, and workforces associated with each goal have been determined, the display FIG. 6 titled “Core Business Processes and Workforce Segments” is opened by clicking the button for step 2 403 on the Main Menu FIG. 4.

The goals will carry over automatically from the Key Strategic Business Goal form FIG. 5 into both 651 in FIG. 6 and into other forms as needed.

For each goal, use the drop-down button 603 to select the Core Business Process 601. If it is preferable to use one's own Core Business Process names, one may simply type them in.

For each goal, use the drop-down buttons 607 to identify the associated sub-processes 605. If it is preferable to use one's own sub-process names, simply type them in.

For each sub-process, use the drop-down button 611 to identify the associated Critical Workforce Segment 609. If it would be preferable to use one's own workforce names, they can be typed in. Comments may also be added by typing them into box 617.

Adding your workforces to this sheet will cause them to be represented properly and will also add them to the drop-down lists on the subsequent forms. New critical workforce segments can be added by typing them into box 613.

In this exemplary embodiment, one can also add their own core business processes and sub-processes to the drop-down lists here if desired, but it is highly desirable that the workforces be added. Buttons 625, 627, 629 and 631 are used to move to forms for entry of the next goal 631 or previous goal 629 process. Although not shown in this drawing, the form also has the normal Navigate Buttons for next or previous form and for the main menu.

### Determine Value Levers and Impacts

For each critical workforce segment, determining value levers and their impacts will help to identify which of their activities are critical to achieving the business goals, and to specify the way in which those activities impact the goal.

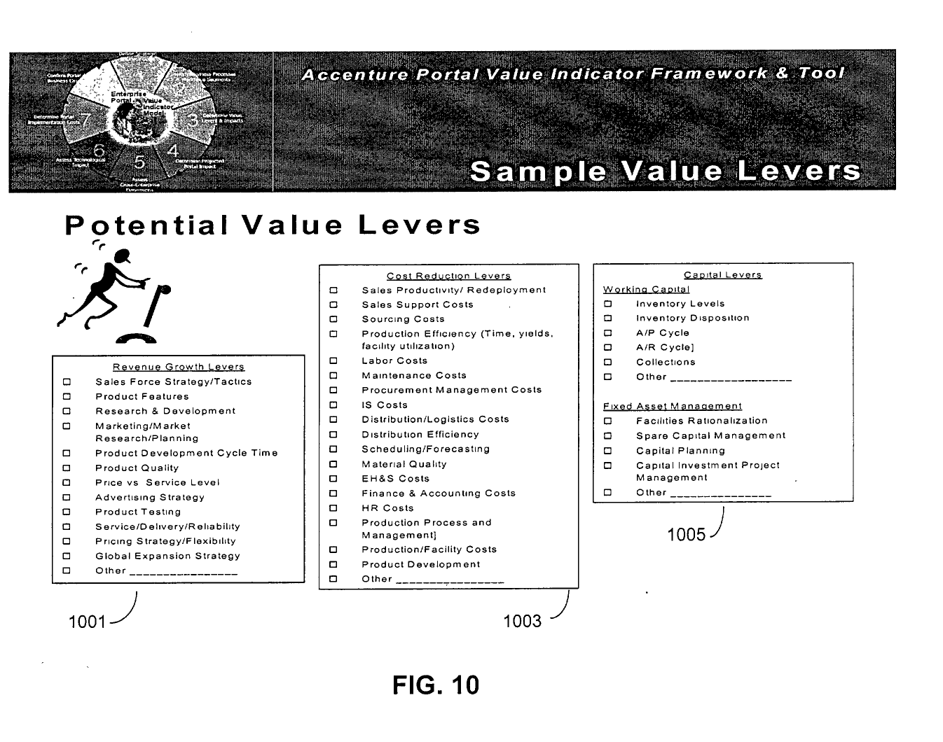

This is facilitated by an understanding of workforce segments and their value levers. An ability to classify levers by their impacts is helpful. FIG. 10 depicts various potential value levers which may affect revenue 1001, costs 1003 and Capital and fixed asset management 1005.

For each goal/sub-process workforce, determine value levers and impacts. Each workforce has levers that affect the goals differently. A value lever is something the workforce does that is critical to achieving the goal. For example, if the goal is to increase sales by 15% in the current fiscal year, “visiting potential buyers to discuss the product” is a value lever, but “participating in performance reviews” may not be. Sometimes the levers may overlap between goals; sometimes they won't.

Each value lever affects the business in different ways. When one determines a lever's impact, one determines if it affects the business primarily by affecting costs, revenue, or competitive advantage.

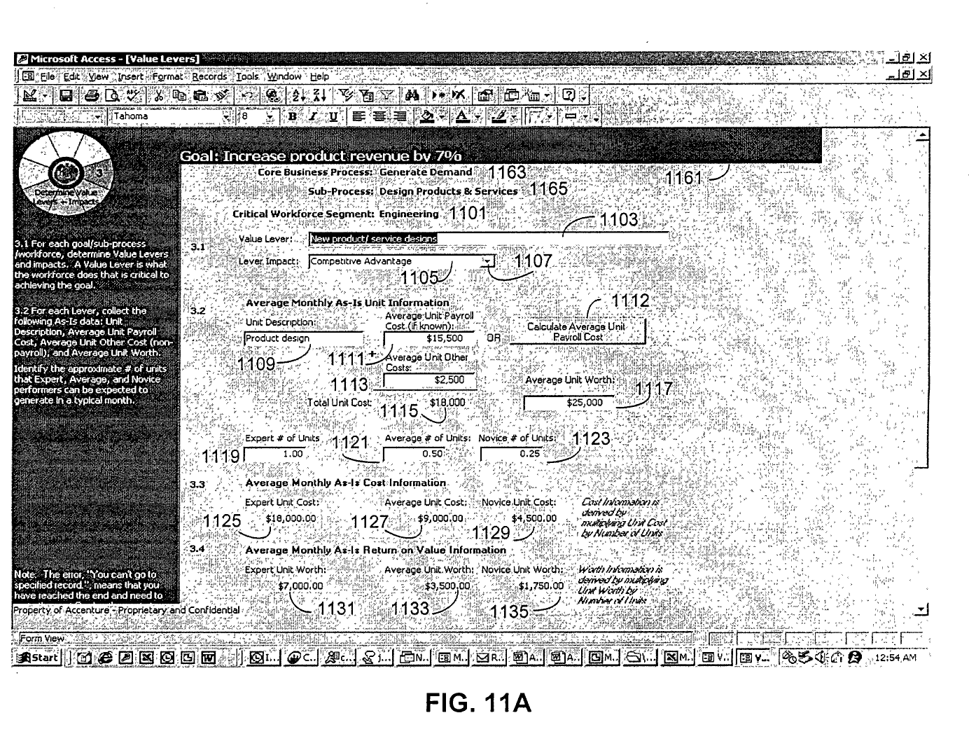

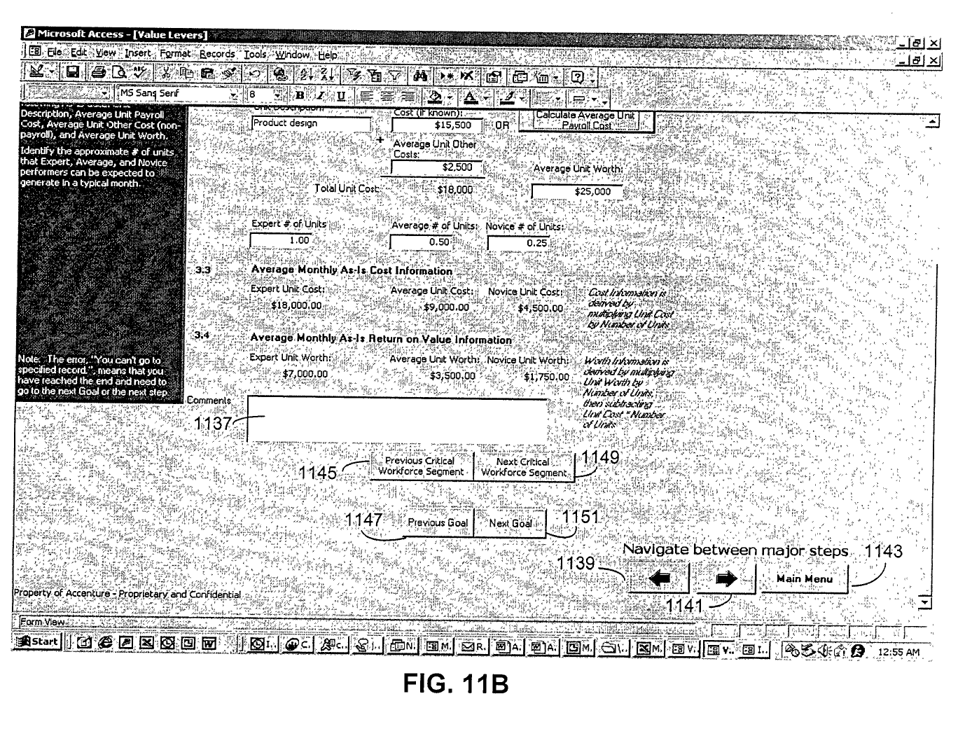

When ready to enter the levers and their impacts into the-Portal Value Calculator Tool, open the “Determine Value Levers and Impact” Form by selecting button for step 3405 in FIG. 4. FIGS. 11A and 11B depict an As-is value screen. In the As-Is screen form in FIG. 11A, the goals 1161, core business processes 1163, sub-processes 1165, and critical workforce segments 1101 will carry over automatically from the previous forms.

On the related display FIG. 11A, for each workforce 1101, the user would type the value levers in the space provided 1103.

For each value lever 1103, the drop-down button 1107 is used to label how the lever primarily affects the business by selecting revenue, cost, or competitive advantage 1105.

### Conduct as-is Value Analysis

In the exemplary embodiment the user of the invention next documents current “As-Is” operations to benchmark how value is generated “without” an enterprise portal. For each lever 1103, the As-Is Analysis documents costs, returns, and net profits for the current mode of doing business. The inputs to the system include Client financial data regarding workforce salaries, hours, time estimates per value lever, costs, and returns. Outputs from the system include Per workforce segment's levers, costs, returns, and profits.

Referring again to FIG. 11A, for each lever, the following as-is data is collected:

What is the unit of measurement for the lever? (e.g. orders processed, proposals written, individuals contacted) 1109

On a monthly basis, what does a unit cost in terms of worker-time? 1111 This can be calculated by using the following formula:

(avg. segment worker's salary)(days required for 1 worker to produce 1 unit)(# of people required for 1 unit) # of working days per month

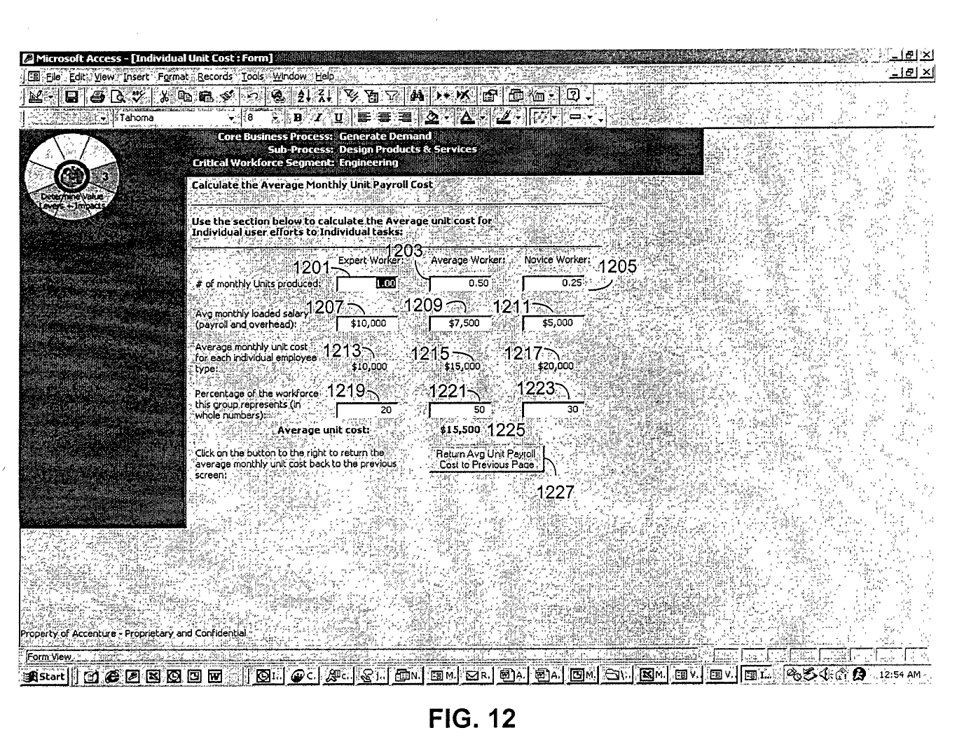

Otherwise, clicking on the button labeled “Calculate Average unit payroll costs” 1112 takes the user to the form for “Individual unit cost” FIG. 12. Here one enters the number of monthly units produced 1201, 1203 and 1205, the average monthly salary 1207, 1209 and 1211, and the average monthly unit cost per employee type 1213, 1215 and 1217. Finally, data representing the percentage of the related workforce that is expert, average and novice are entered 1219, 1221 and 1223, and the average unit cost is calculated and displayed 1225. Clicking on button 1227 returns to the previous page.

Average unit other costs (non-payroll) are entered in box 1113 and a total unit cost is displayed 1115.

What is a single unit of work worth? 1117

For expert 1119, average 1121, and novice performers 1123, for approximately how many units can they be expected to generate costs in an average month? Average monthly as-is cost is shown at 1125, 1127 and 1129. These costs are calculated by multiplying unit cost by number of units.

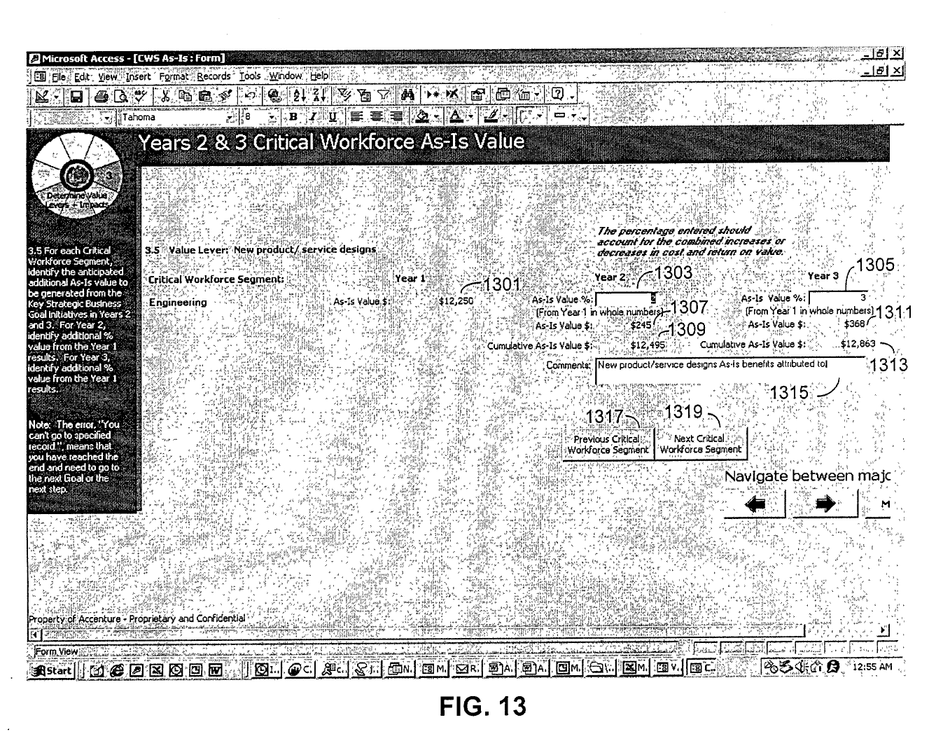

For expert, average, and novice performers, for approximately how many units can they be expected to generate returns in an average month? As-is average monthly return on value information is shown at 1131, 1133 and 1135. Worth information is derived by multiplying unit worth 1117 by number of units then subtracting unit cost 1115 times number of units. The user then repeats the above process for each lever impact 1105 and then for each critical workforce segment 1101 by using the buttons 1145, 1147, 1149 and 1151 until all workforces and all goals have been covered. Then clicking on button 1141 navigate to the next step takes the user to the “Years 2 and 3 Critical Workforce As-Is Value Screen” FIG. 13. From the previous form FIGS. 11A and 11B, the “total Year 1 average unit worth” (the sum of 1131, 1133 and 1135) was calculated and is shown on form FIG. 13 in box 1301. The user enters the percent increase or decrease in Return on Value predicted for years 2 and 3 1303 and 1305. The tool calculates the As-Is value 1307 and 1311 and cumulative As-Is value 1309 and 1313. Comments may be added in box 1315 and button 1319 is used to advance to the next workforce segment where similar data for years 2 and 3 are entered until all workforces and goals have been covered.

### Conduct Portal Value

The next step in the process involves generating a “To-be” set of costs related to what using a portal would produce. In the exemplary embodiment, for each lever, the Portal Value tool documents costs, returns, and net profits for the projected (with-portal) mode of achieving the key strategic business goals. The inputs are Client financial data regarding workforce salaries, hours, time per lever estimates, units, costs, and returns; Estimates for how a portal affects a given workforce; and Benchmarking data. Outputs are Per workforce segment's levers, projected costs, returns, and profits.

After the As-Is Analysis is completed, the user will need to use benchmarking information, input from clients, and experience to help project how the values will change if a portal is introduced.

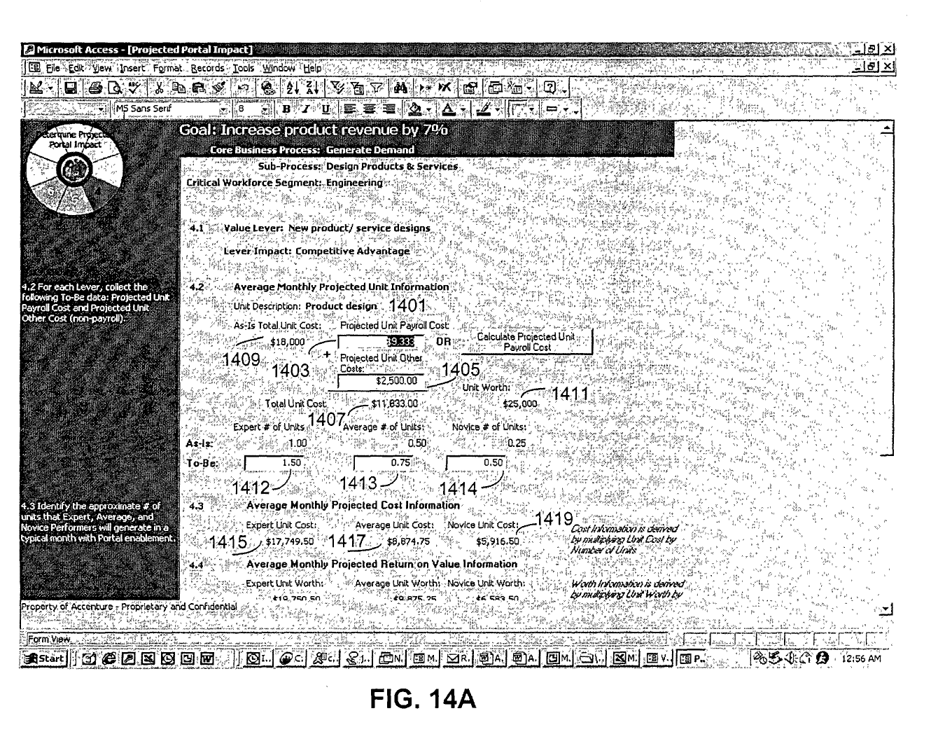

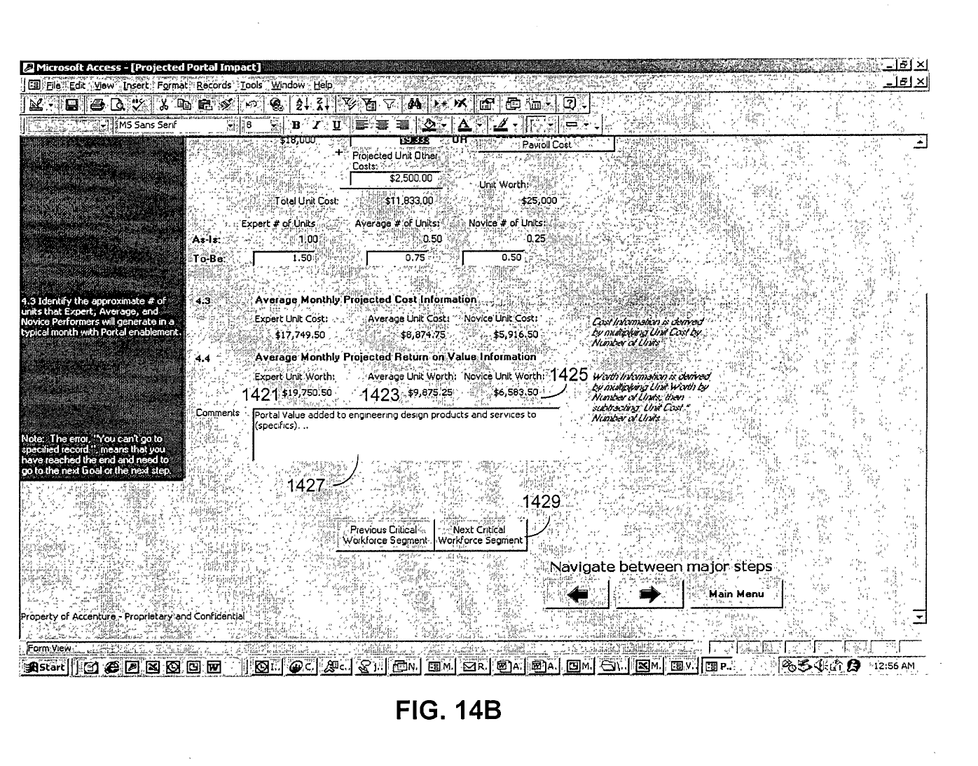

When the user is ready to document the projections, recording the projected data is very similar to recording the as-is data as described above. The user begins by opening the relevant goal's Projected Portal Impact form FIGS. 14A and 14B. This form can be opened by clicking the button for step 4 407 on the Portal Value Calculator main menu (FIG. 4).

For each value lever's projected unit of measure 1401, insert the projected 1405, and other costs unit cost 1403. A total projected unit cost is calculated 1407. The As-Is unit cost 1409 and unit worth 1411 are carried over from the As-Is data form FIG. 11A.

Type the number of projected units for which an expert 1412, average 1413, and novice 1414 performer might be expected to incur costs. The tool will automatically calculate the cost per proficiency level based on each level's number of units and the unit cost. 1415, 1417 and 1419. The tool will also automatically calculate the return per proficiency level based on each level's number of units and the unit worth. 1421, 1423 and 1425.

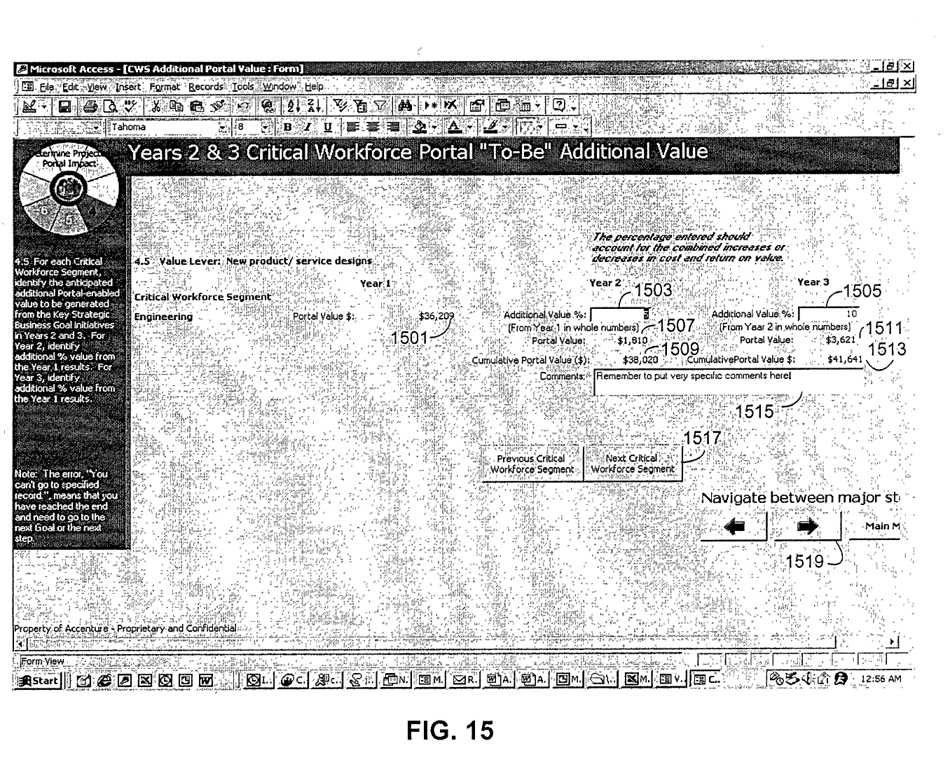

Referring now to FIG. 15 the factors 1503 and 1505 for additional percent of projected increase in value in years 2 and 3 are entered. The projected Portal Value in years 1 (1501), 2 (1507) and 3 (1511) are calculated, as well as the cumulative values for years 2 and 3 1509 and 1513. Comments can be entered in box 1515. Working between forms FIGS. 14A and 14B and FIG. 15 the user enters the relevant data for all Critical Workforce segments by using buttons 1429 and 1517. When completed, the user proceeds to the next form by clicking button 1519.

### Assess Cross-Enterprise Efficiencies

Assessing cross-enterprise efficiencies ensures that specific business portal benefits that may not necessarily link directly to a goal are considered. The exemplary embodiment provides a mechanism for displaying the difference between as-is and projected financials for general operational efficiencies not related to specific business goals.

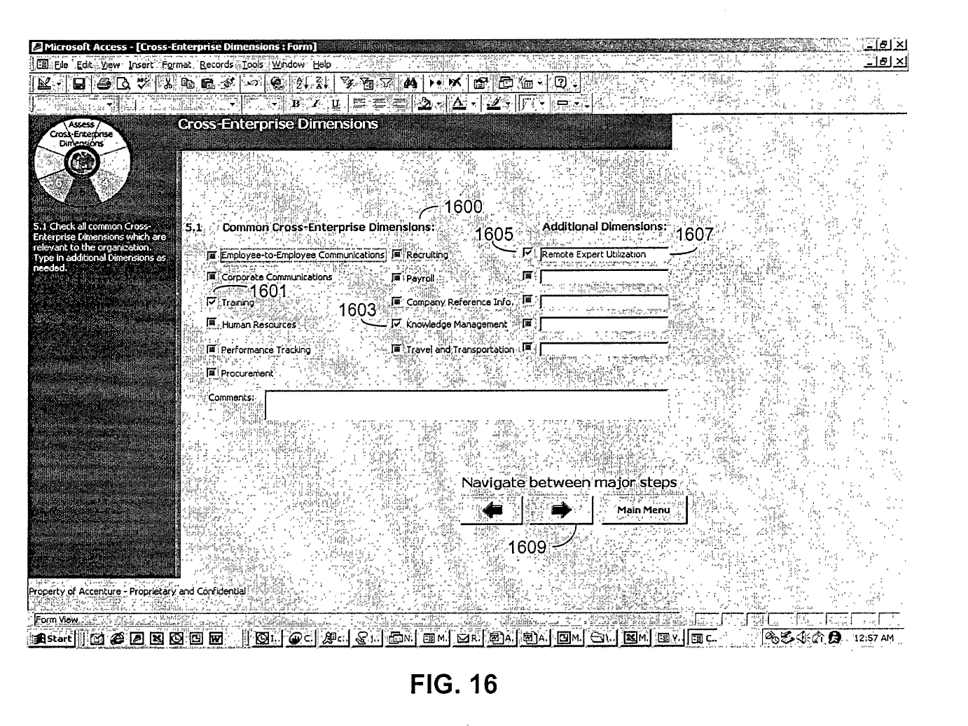

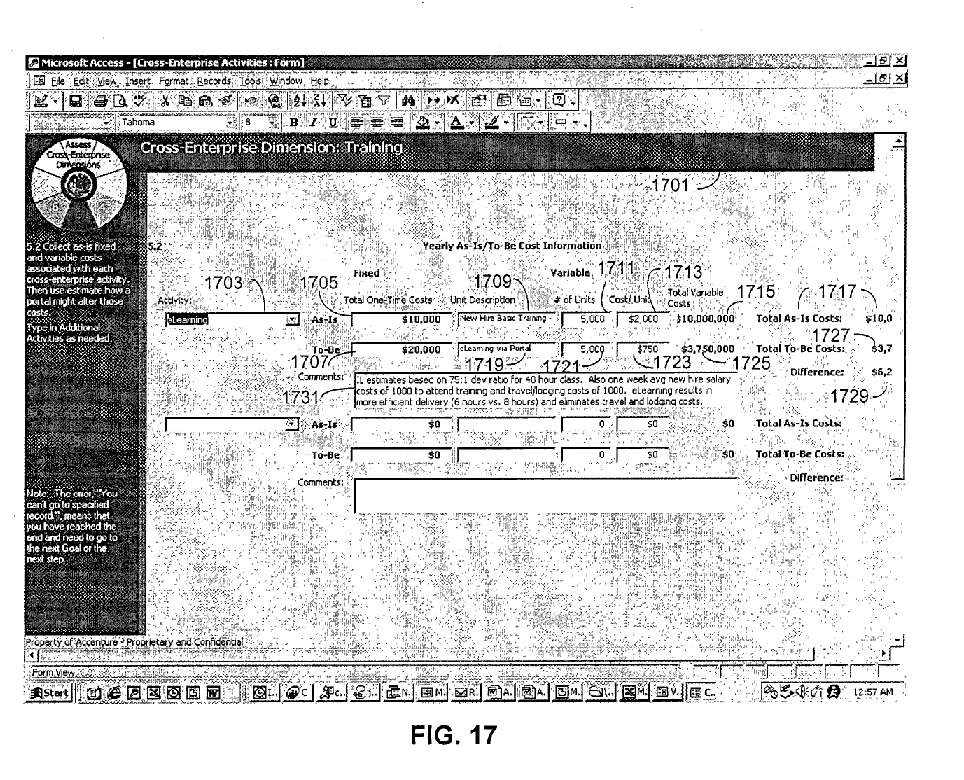

The ways that a portal can support the key strategic business goals are of primary importance when putting together a business case, but it's also important to account for other ways that it can improve the business. The cross-enterprise Dimensions form FIG. 16 contains a list of typical cross-enterprise functional areas and the activities associated with them. This form is reached by clicking on the button for step 5 409 in the main menu FIG. 4, or by clicking the next form button on FIG. 15. In an exemplary embodiment, a user begins an assessment by reviewing the list of activities 1600 and determining which are relevant to the company's business. If there are additional items that the user feels should be considered, they can be added to the list by typing them into the additional dimensions blocks 1607. The user selects the desired entries from the list 1600 by clicking on the boxes chosen, for example training 1601, knowledge management 1603, and Remote Expert utilization 1605. The user clicks on the next screen navigate button 1609 which brings up the “Cross-Enterprise Dimension: Training” screen form FIG. 17. The activity illustrated is elearning 1703.

For each activity, the user will record the as-is state of affairs. The user begins by recording any monthly one-time costs 1705.

The user may continue by recording the units of measure 1709, cost per unit 713, and number of units 1711 for any monthly variable costs. The tool will automatically calculate the total variable costs 1715 and total as-is costs 1717 based on these entries.

After documenting the as-is situation, the user can record the projected monthly one-time costs 1707.

The user continues by recording the projected units of measure 1719, cost per unit 1723, and number of units 1721 for any monthly variable costs. The tool will automatically calculate the total variable costs 1725 and total projected costs 1727 based on these entries.

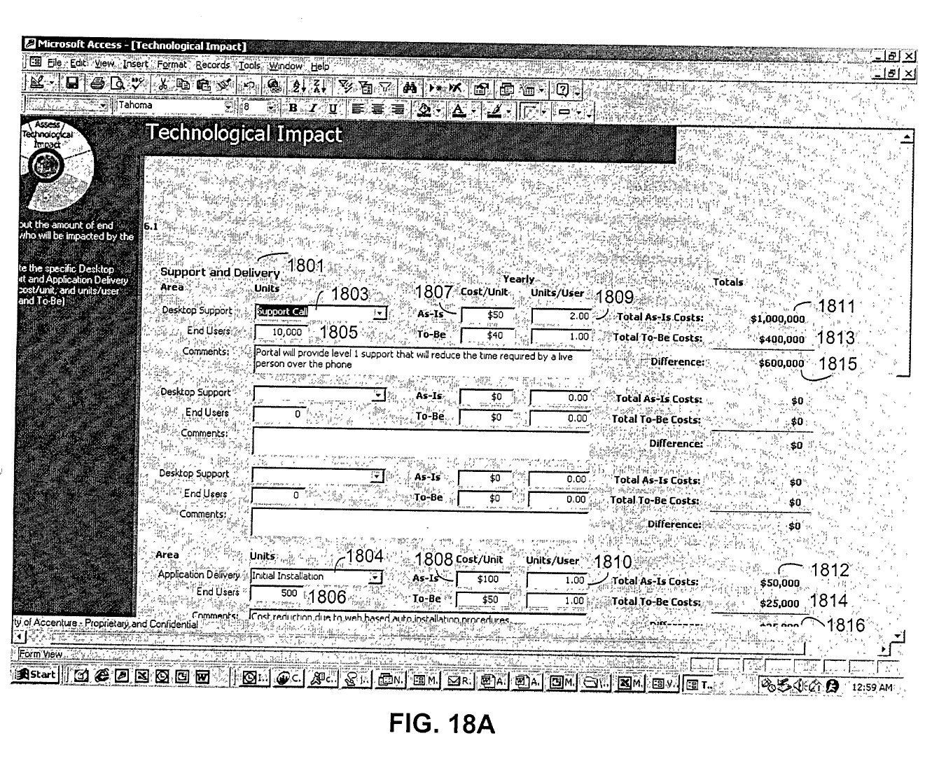

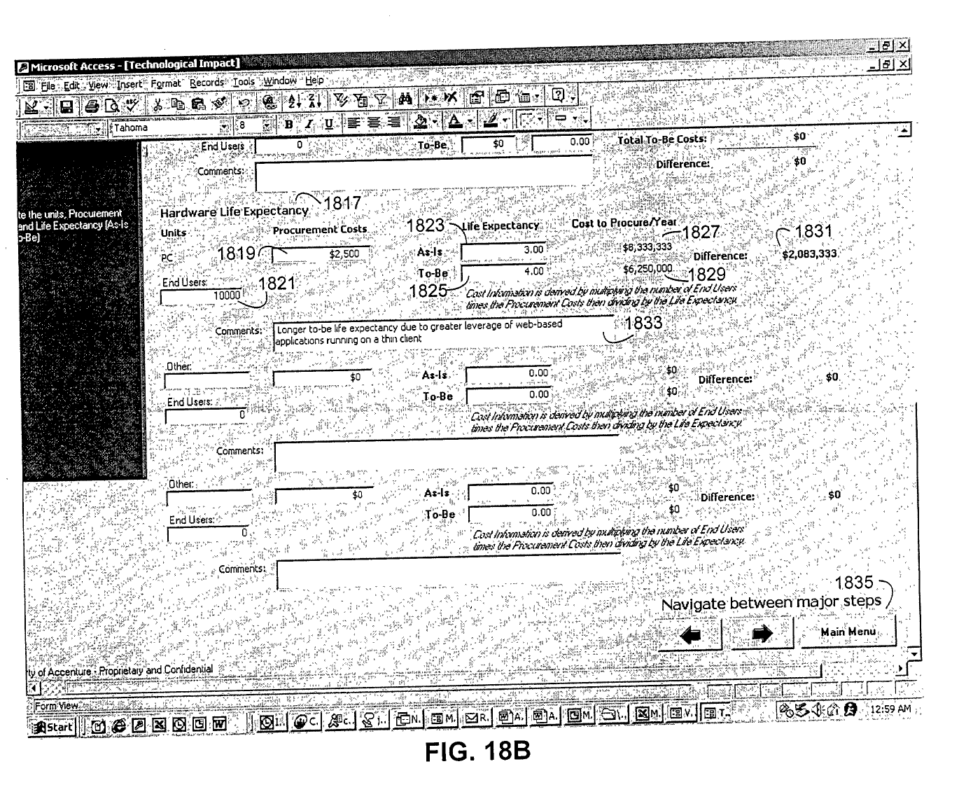

Based on the difference between the monthly as-is costs and the monthly projected cost, the tool will automatically calculate the difference 1729 in the total As-Is cost 1717 and the total To-Be cost 1727. The user may continue by entering more data for a next activity if desired. The form for the next Dimension is brought up by clicking on the “Next Dimension” button (not shown) at the bottom of the form. If completed, the user may click on the next form button (not shown) or may return to the main menu FIG. 4 and click on the button for step 6 411 to go to the Assess Technological Impact form FIGS. 18A and 18B.

### Assess Technological Impact

In the exemplary embodiment, the next step is to assess the technological impact which will help to quantify specific hardware, software, and related processing costs and benefits associated with implementing and operating an enterprise portal. Inputs required include Hardware/software costs; operation and amortization schedules and costs; Processing costs and Technology support costs. The output of this phase is the difference between as-is and projected financial technological impact.

In addition to introducing cross-enterprise efficiencies, an enterprise portal often introduces technological efficiencies, particularly in the areas of support, delivery, and hardware life expectancy. In the exemplary embodiment, the “Technological Impact” form FIGS. 18A and 18B is used to account for these improvements

The user enters the current number of end-users in box 1805. for Desktop support, and in box 1806 for application delivery.

For both desktop support and application delivery 1801, the user records the monthly cost per unit 1807, 1808 and monthly units per user 1809, 1810. The tool will automatically calculate the total monthly As-Is cost 1811 based on these entries.

For both desktop support and application delivery 1801, the user similarly records the projected (to-be) monthly cost per unit and projected (to-be) monthly units per user. The tool will automatically calculate the projected total (to-be) monthly cost 1813, 1814, as well as the difference between the projected and as-is costs 1815 and 1816.

To assess hardware life expectancy 1817, the user records the PC procurement cost in box 1819, and the number of end users in box 1821.

Next, the user records the as-is PC life expectancy 1823. The tool will will automatically calculate the yearly procurement costs 1827 based on these entries.

The user then records the projected PC life expectancy 1825. The tool will automatically calculate the projected yearly procurement costs 1829 based on these entries, as well as the difference 1831 between the as-is hardware life expectancy 1827 and the projected hardware life expectancy 1829.

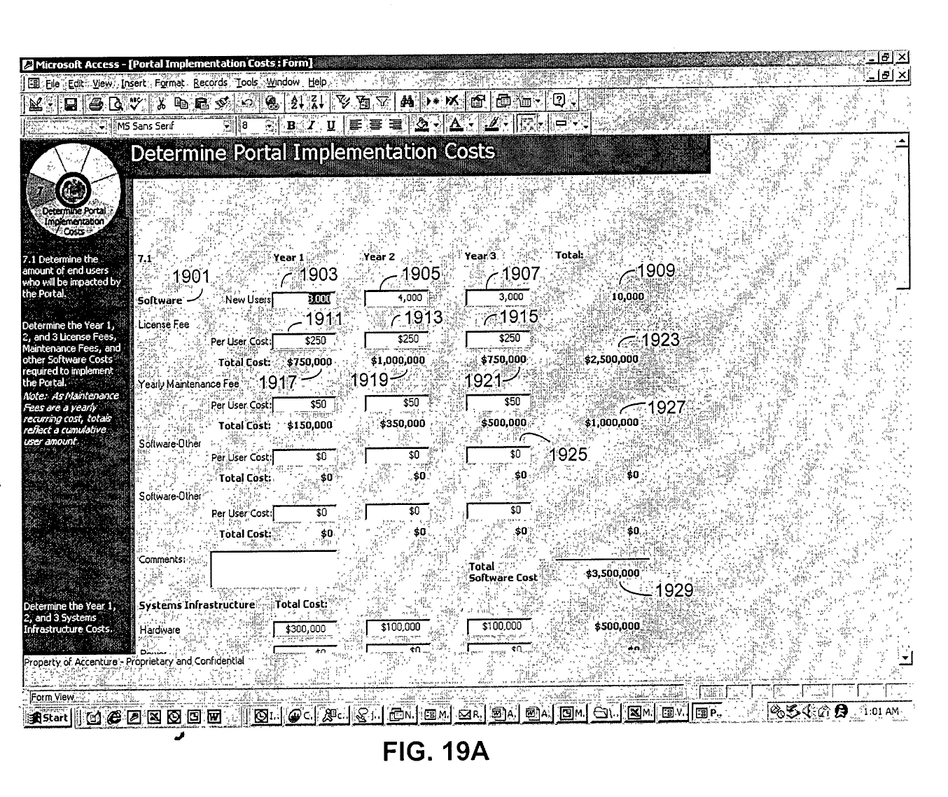

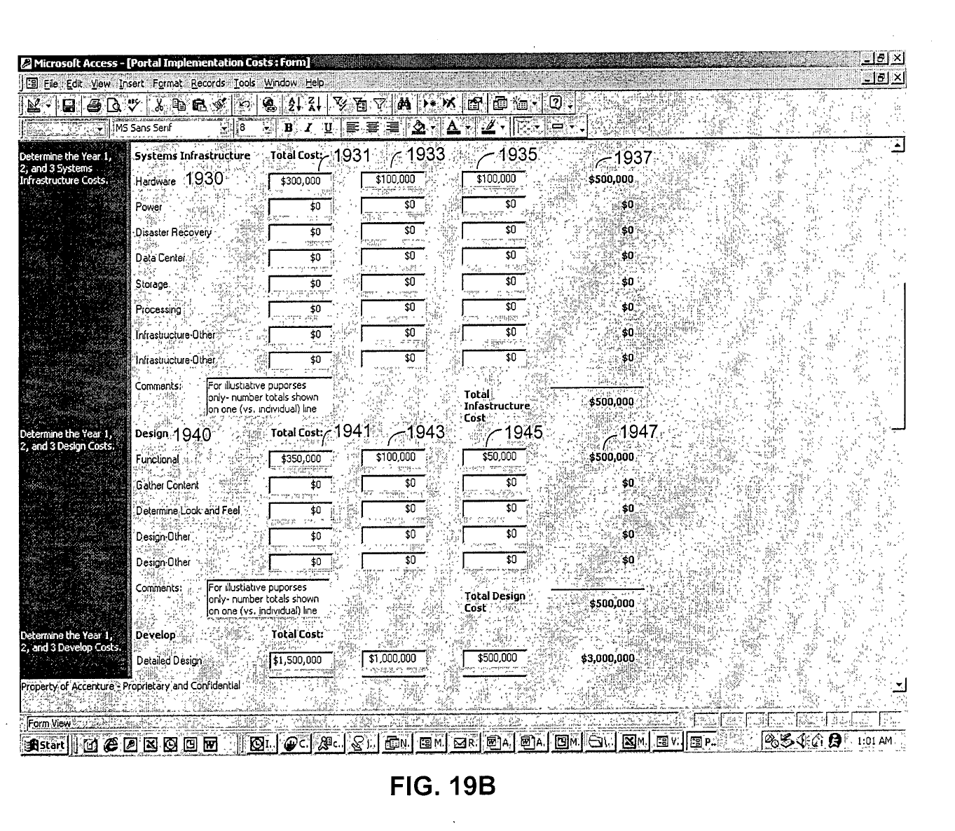

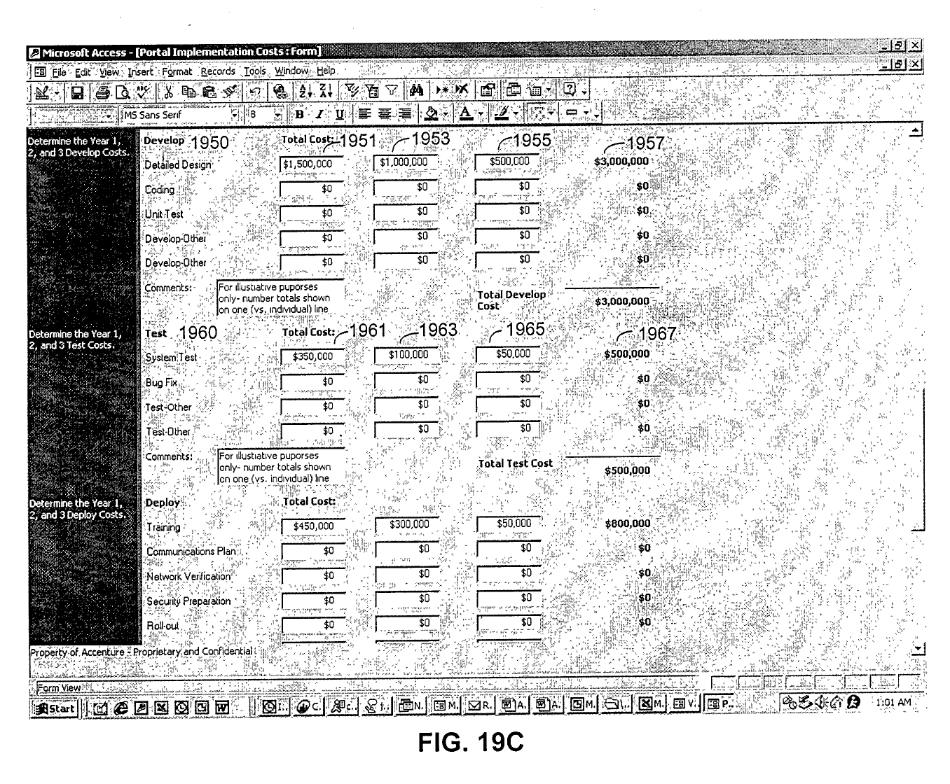

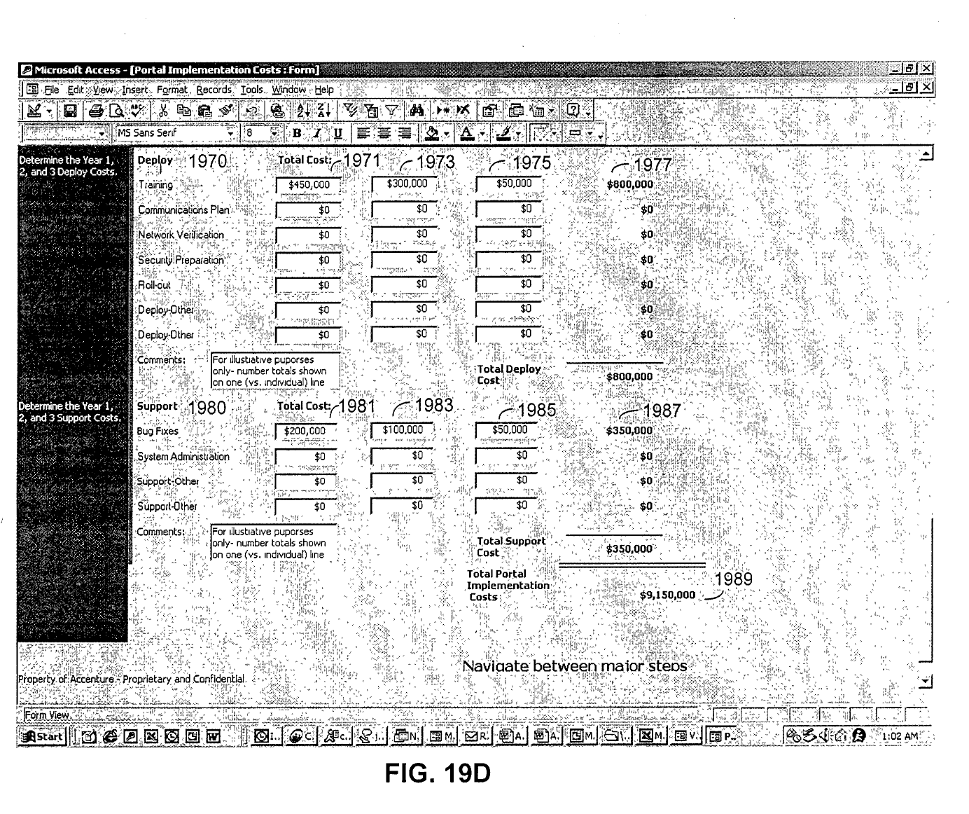

Finally, the user may insert any explanatory comments in box 1833. The user generally returns to the main menu FIG. 4 by clicking on button 1835. Thereafter, clicking on the button for step 7 413 in FIG. 4 will bring up the form titled “Determine Portal Implementation Costs” FIGS. 19A through 19D.

Referring now to FIGS. 19A through 19D Portal Implementation Costs are entered into the system for the following cost elements: Software costs 1901; Systems Infrastructure costs 1930; Design costs 1940; Development costs 1950; Deployment costs 1979; and Support costs 1980. Typically, for the software cost elements the number of new users predicted are entered for years 1, 2 and 3 in boxes 1903, 1905 and 1907. The cost per user for each year is also entered 1911, 1913 and 1915. The tool computes the total cost for each year 1917, 1919 and 1921 and for the 3 year horizon 1923. Yearly data for maintenance fees are also entered in the relevant boxes 1925 and the total maintenance for the 3 year horizon displayed 1927 as well as the total software cost for the 3 years 1929.

Hardware costs for the 3 year period are entered in boxes 1931, 1933 and 1935. and the total cost is displayed 1337. Boxes are available in the systems infrastructure section of the form for entering other known or predicted costs for items such as Power costs, disaster recovery costs, etc.

System design costs 1940 are entered. At a minimum, functional design costs would be entered for each year 1941, 1943 and 1945 with the total functional design cost being displayed 1947.

Similarly Development costs 1950, test costs 1960, deployment costs 1970 and support costs 1980 are entered into the form in the appropriate boxes. A total Portal Implementation Cost 1989 is displayed. By clicking on the next form navigate button (not shown) the tool takes the user to the Report form screen FIG. 20.

### Confirm and Refine Business Case

In an exemplary embodiment, a “Confirming and Refining” step consists of reviewing the business case to verify that the assumptions and numbers are accurate and make corrections as desired.

This step, in an exemplary embodiment, is performed by reviewing and discussing the results shown in the Business Case Summary Reports which can be accessed by clicking on the step 8 button 415 in the main menu screen FIG. 4. The reports available are listed on the Value Reports form FIG. 20 and will be display by clicking on one of the report buttons 2001.

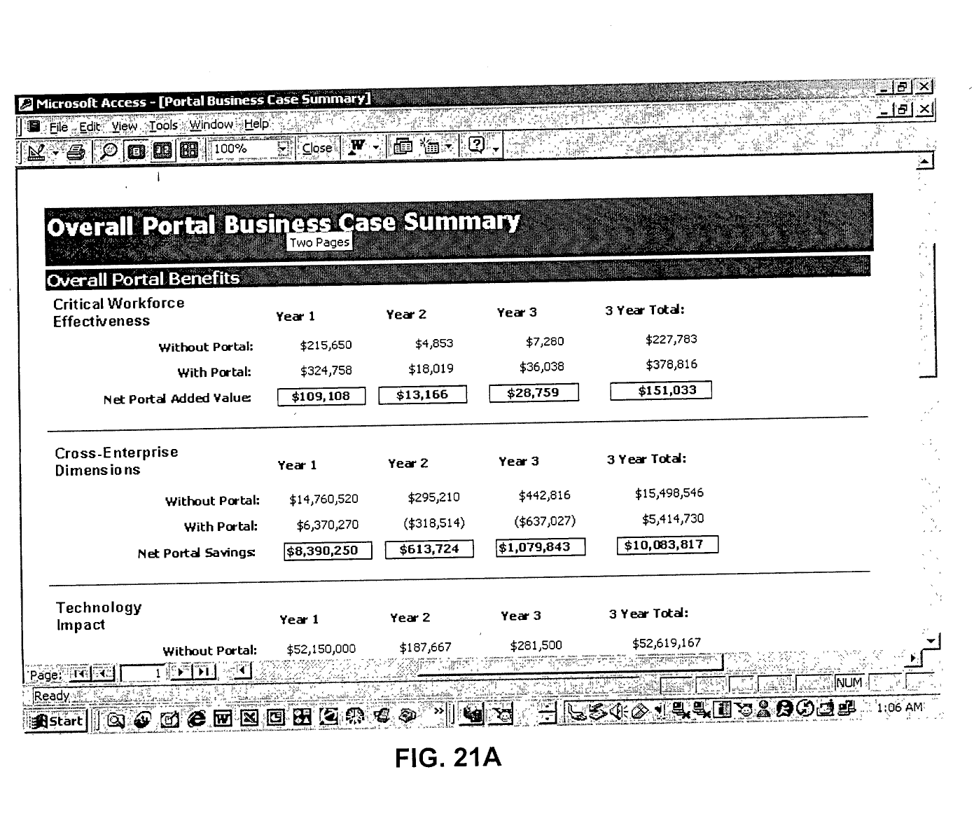

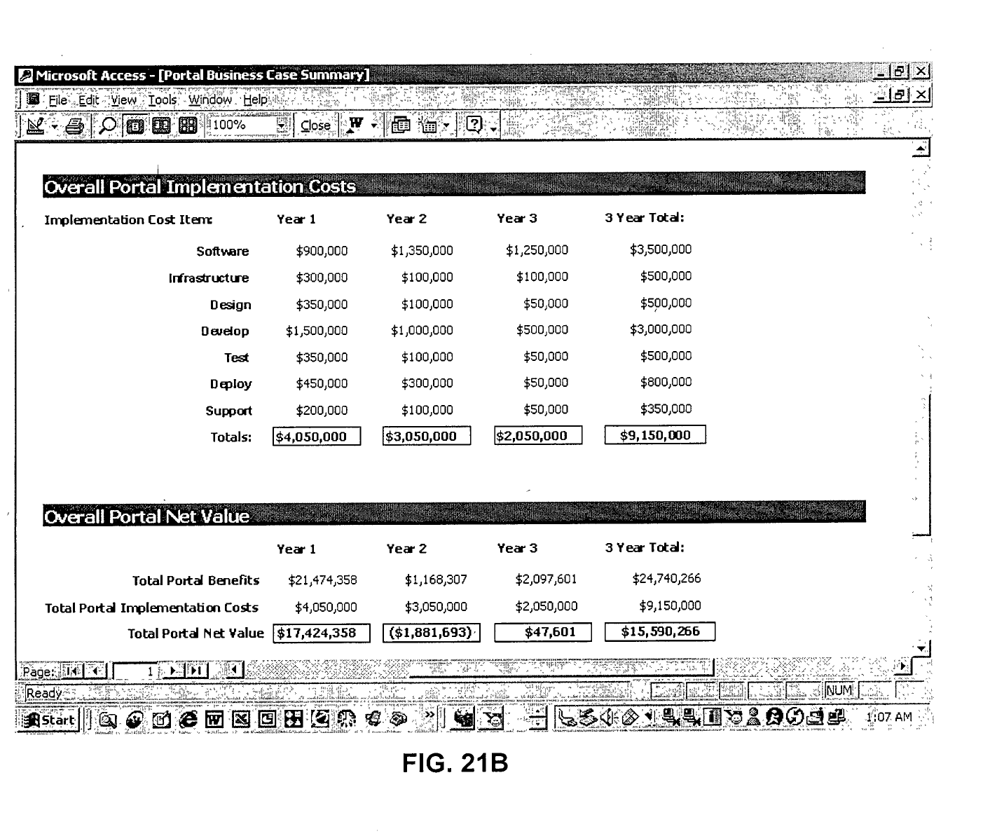

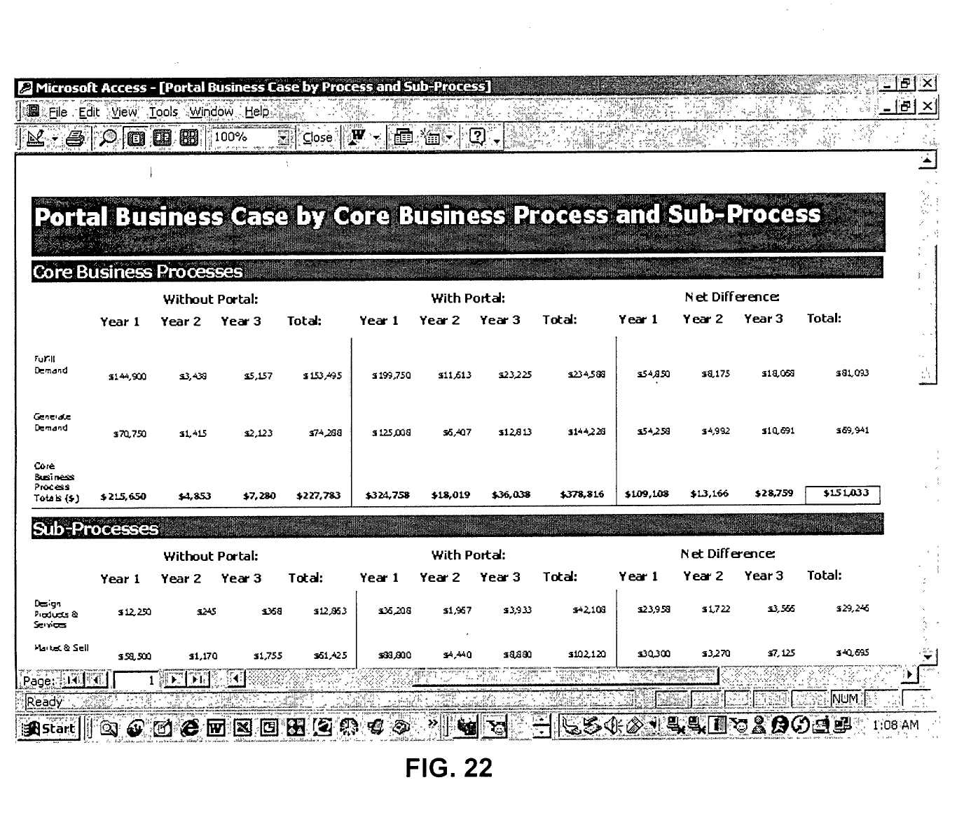

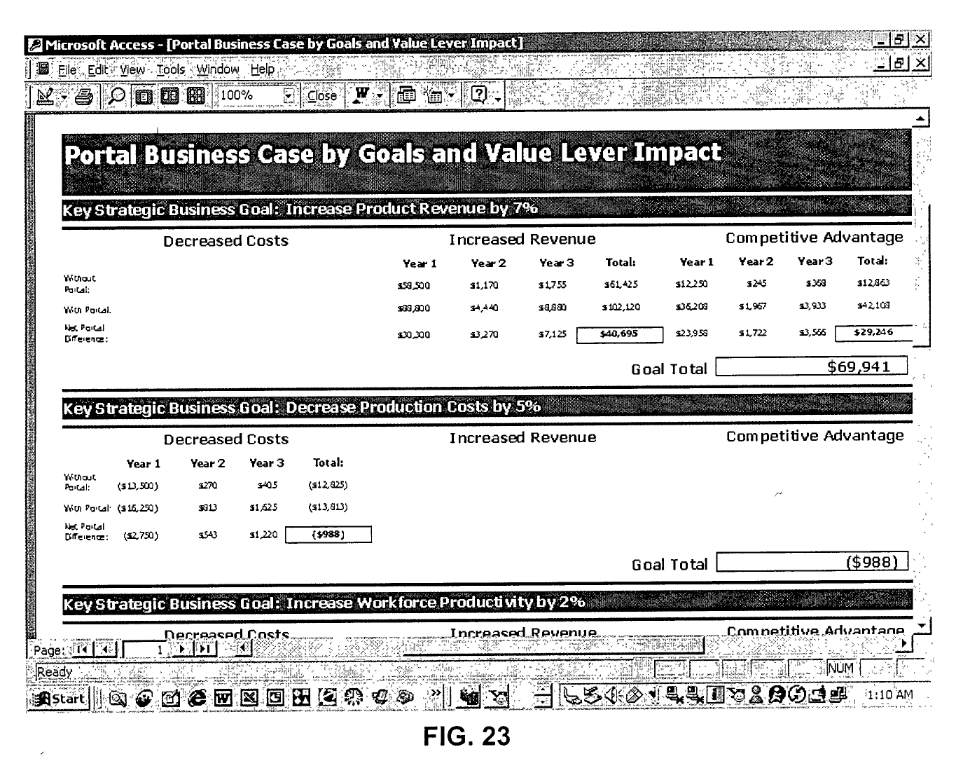

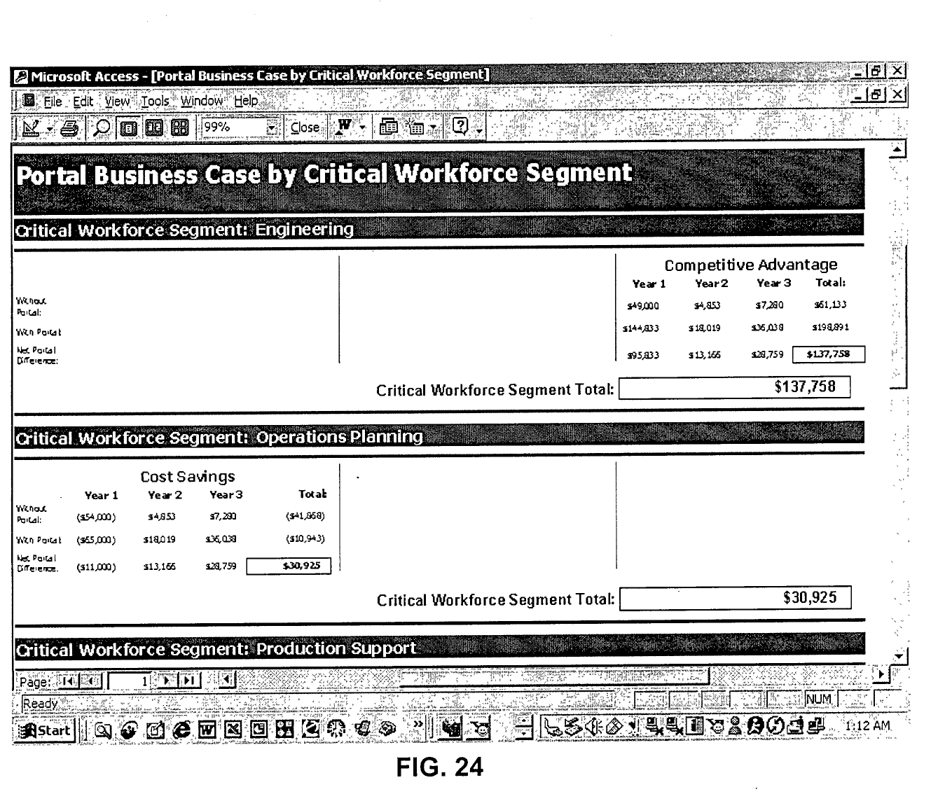

An exemplary report for the Overall Business Case Summary is shown in FIGS. 21A and 21B. An exemplary report for the Portal Business Case by Core Business Process and Sub-process is shown in FIG. 22. An exemplary report for the Portal Business Case by Goals and Value Lever Impact is shown in FIG. 23. An exemplary report for the Portal Business Case by Critical Workforce Segment is shown in FIG. 24.

Those skilled in these arts will recognize that equivalent mechanisms and frameworks may be substituted for those described in the exemplary embodiment shown herein. Such equivalent input forms could be used to produce similar functions, to produce similar results in a similar way. Similarly, various computer systems designs and program implementations, including the application of the invention other operating systems architectures and domains, may be used without departing from the spirit and scope of the invention which is measured by the following claims.

We claim:

1. A method for using a computer implemented framework for-a technically efficient process to generate summary costs and benefits for a proposed enterprise portal, the method comprising the acts of:
providing a computer having a display system, a processor, memory, a database and connections to the Internet;
defining and inputting into the computer, data representing one or more strategic business goals;
identifying and inputting into the computer system, data representing one or more processes and one or more workforce segments related to achieving one or more of the strategic business goals;
determining for each of the one or more workforce segments, first data representing one or more value lever that can impact a strategic business goal and second data indicating how each lever impacts the strategic business goal , and inputting the first data and the second data into the computer system;
determining and inputting into the computer, for each of the one or more value lever, third data which is designated “as-is” data which represents current operating data;
determining and inputting, for each of the one or more value lever, fourth data which is designated “to-be” data which represents expected operating data;
designating a sub-set of a list of cross-enterprise functional areas and activities as activities which are relevant to the proposed enterprise portal;
inputting into the computer system, as-is, fixed and variable cost data for each activity in the designated sub-set of cross-enterprise functional areas;
inputting into the computer system, technology related cost data including data representative of at least one of hardware costs, software costs, testing costs, processing costs and support costs, from which the computer system can compute the difference in costs and benefits between as-is and to-be financial technological impact;
using summary data outputted by the computer system to review generated costs for business case and comparison scenarios for the proposed enterprise portal;
whereby as-is and to-be costs and benefits for the proposed enterprise portal can be evaluated.

2. The method of claim 1 wherein the acts of inputting data into the computer further comprise inputting the data into an interconnected set of pre-defined Microsoft Access database tables.

3. An apparatus designed to produce a technically efficient process to generate summary costs and benefits for a proposed enterprise portal comprising:
a computer system having a display system, a processor, memory, a database and connections to the Internet;
means for inputting into the computer system, data representing one or more strategic business goals, data representing one or more processes and one or more workforce segments related to achieving one or more of the strategic business goals, data representing one or more value levers that can impact a strategic business goal and data indicating how each lever impacts the strategic business goal, data which is designated “as-is” data which represents current operating data and for each of the one or more value levers, data which is designated “to-be” data which represents expected operating data;
means for inputting into the computer system, for each of a sub-set of cross-enterprise functional areas and activities which are relevant to the proposed enterprise portal, data representing as-is, fixed and variable cost data for each activity in the designated sub-set of cross-enterprise functional areas;
means for inputting into the computer system, technology related cost data including data representative of at least one of hardware costs, software costs, testing costs, processing costs and support costs;
means for computing the difference in costs between as-is and to-be financial technological impact; and
means for displaying summary data outputted by the computer system to review costs for business case and comparison scenarios for the proposed enterprise portal.

4. A server apparatus designed to produce a technically efficient process to generate summary costs and benefits for a proposed enterprise portal comprising:
a computer having a display system, a processor, memory, a database and connections to the Internet and thereby to one or more client computers;
a first programming mechanism in the computer configured to receive data from a client computer representing one or more strategic business goals, data representing one or more processes and one or more workforce segments related to achieving one or more of the strategic business goals, data which is designated “as-is” data which represents current operating data and for each of the one or more value levers, and data which is designated “to-be” data which represents expected operating data;
a second programming mechanism connected to the first programming mechanism, and configured to receive data from the client computer representing, for each of a sub-set of cross-enterprise functional areas and activities which are relevant to the proposed enterprise portal, data representing as-is, fixed and variable cost data for each activity in the designated sub-set of cross-enterprise functional areas; means for computing the difference in costs between as-is and to-be financial technological impact; and
a third programming mechanism, connected to the first and second programming mechanisms, configured to compute summary data for the costs and benefits of the proposed enterprise portal and to transmit the summary data to the client computer whenever requested to do so.

5. A computer program product embedded on a computer readable memory for use with a computer having a display system, a processor, memory, a database and connections to the Internet and thereby to one or more client computers, the computer program product designed to produce a technically efficient process to generate summary costs and benefits for a proposed enterprise portal comprising:
a first programming mechanism in the computer configured to receive data from a client computer representing one or more strategic business goals, data representing one or more processes and one or more workforce segments related to achieving one or more of the strategic business goals, data which is designated “as-is” data which represents current operating data and for each of the one or more value levers, and data which is designated “to-be” data which represents expected operating data;
a second programming mechanism electronically connected to the first programming mechanism, and configured to receive data from the client computer representing, for each of a sub-set of cross-enterprise functional areas and activities which are relevant to the proposed enterprise portal, data representing as-is, fixed and variable cost data for each activity in the designated sub-set of cross-enterprise functional areas; means for computing the difference in costs between as-is and to-be financial technological impact; and
a third programming mechanism, connected to the first and second programming mechanisms, configured to compute summary data for the costs and benefits of the proposed enterprise portal and to transmit the summary data to the client computer whenever requested to do so.

6. A method for using a computer implemented framework for a technically efficient process to generate summary costs and benefits for a proposed enterprise portal, the method comprising the acts of:
defining and inputting into a computer system, data representing one or more strategic business goals;
identifying and inputting into the computer system, data representing one or more critical workforce segments related to achieving one or more of the strategic business goals, including cost data related to the one or more critical workforce segments;
inputting into the computer system, cost data for each activity in a designated sub-set of cross-enterprise functional areas which are relevant to the proposed enterprise portal;
inputting into the computer system, technology related cost data representative of at least one of hardware costs, software costs, testing costs, processing costs and support costs; and
generating summary data outputted by the computer system for business case and comparison scenarios for the proposed enterprise portal;
whereby costs and benefits for the proposed enterprise portal which include critical workforce segments and cross-enterprise functional areas can be evaluated.

7. The method of claim 6 comprising the additional act of identifying and inputting into the computer system, data representing one or more key value levers related to the one or more critical workforce segments, whereby costs and benefits for the proposed enterprise portal which include critical workforce segments and key value levers can be evaluated.

8. A method for using a computer implemented framework for a technically efficient process to generate summary costs and benefits for a proposed enterprise portal, the method comprising the acts of:
inputting into a computer system, data representing one or more strategic business goals;
inputting into the computer system, data representing one or more critical workforce segments related to achieving one or more of the strategic business goals, including cost data related to the one or more critical workforce segments;
inputting into the computer system, cost data for each activity in a designated sub-set of cross-enterprise functional areas which are relevant to the proposed enterprise portal;
inputting into the computer system, data representative of at least one of hardware costs, software costs, testing costs, processing costs and support costs for products and services required to implement the proposed enterprise portal; and
generating summary data outputted by the computer system for business case and comparison scenarios for the proposed enterprise portal;
whereby costs and benefits for the proposed enterprise portal which include critical workforce segments and cross-enterprise functional areas can be evaluated.

9. The method of claim 8 comprising the additional act of inputting into the computer system, data representing one or more key value levers related to the one or more critical workforce segments, whereby costs and benefits for the proposed enterprise portal which include critical workforce segments and key value levers can be evaluated.

10. A method for using a computer implemented framework for a technically efficient process to generate summary costs and benefits for a proposed enterprise portal, the method comprising the acts of:
inputting into a computer system, data representing one or more strategic business goals;
inputting into the computer system, data representing one or more critical workforce segments related to achieving one or more of the strategic business goals;
inputting into the computer system, data representing one or more activities in one or more cross-enterprise functional areas which are relevant to the proposed enterprise portal;
inputting into the computer system, data representing products and services required to implement the proposed enterprise portal; and
generating summary data outputted by the computer system for business case and comparison scenarios for the proposed enterprise portal;
whereby costs and benefits for the proposed enterprise portal which include the effects of critical workforce segments and cross-enterprise functional areas can be evaluated.
